(19) United States
(12) Patent Application Publication
(10) Pub. No.: US 2007/0097229 A1
(43) Pub. Date: May 3, 2007

(54) Image data selecting method and image data processing device

(76) Inventors: Kosuke Matsubara, Tokyo (JP); Keji Mitsuhisa, Sagamihara-shi (JP)

Correspondence Address: STRAUB & POKOTYLO, 620 TINTON AVENUE, BLDG. B, 2ND FLOOR, TINTON FALLS, NJ, 07724, US

(21) Appl. No.: 11/517,960

(22) Filed: Sep. 8, 2006

(30) Foreign Application Priority Data
Sep. 9, 2005 (JP) 2005-262527

(51) Int. Cl. H04N 5/76

(52) U.S. Cl. 348/231.2; 348/231.7

(57) ABSTRACT

In an image data selecting method and an image data processing device, image data to be erased, resized or compressed is automatically selected from image data recorded in a recording medium in accordance with the number of printing times, the number of digital copying times into another recording medium, or the number of times when a reduced image (thumbnail image) shifts to image data (main image) before production of the reduced image, or in accordance with a weighted added value obtained by weighting the numbers to add up the numbers. In consequence, since the image data as an erase, resize or compress processing object is automatically selected regardless of whether or not the image data is new, a necessary recording region can be secured without requiring operator's trouble. Furthermore, since an image of the selected image data or a reduced image of the data is displayed, and an operator confirms the display before the processing is executed, a processing object image can be confirmed beforehand, and erroneous processing of necessary image data is prevented.

### CROSS-REFERENCE TO RELATED APPLICATION

This application is based upon and claims the benefit of priority from prior Japanese Patent Application No. 2005-262527, filed on Sep. 9, 2005, the entire contents of which are incorporated herein by reference.

### BACKGROUND OF THE INVENTION

1. Field of the Invention

The present invention relates to an image data selecting method in which image data to be erased, resized or compressed is automatically selected in order to secure a recording region of recording means in an image data processing device such as a video disk recorder, a video tape recorder or a digital camera that records the image data in a recording medium such as an optical disk, a magnetic tape or a magnetic disk and that reproduces the data if necessary, and an image data processing device which performs the method.

2. Description of the Related Art

In an image data processing device which records and reproduces image data, in a case where a remaining amount of a recording medium is reduced to be too little, unless an operator selects the image data to be erased from the image data recorded in the recording medium, and erases the selected data to secure a necessary recording region, the image data cannot be recorded. However, since an operation of selecting and erasing the image data to be erased is laborious, the operator does not like to perform the operation.

Therefore, in the case where the remaining amount of the recording medium is reduced to be too little, as described in, for example, Japanese Patent Application Laid-Open No. 2001-148158, unprotected image data is detected and erased in order from the image data having an old recording date among the image data recorded in the recording medium to secure the necessary recording region.

Moreover, resizing of the image data recorded in the recording medium is broadly performed. That is, a size of the data is reduced to overwrite the data, the data is compressed at a compression ratio in accordance with the remaining amount of the recording medium, or the compression ratio of the image data having the old recording date is raised to compress and overwrite the data to secure a new recording region.

However, in the above conventional method, even in a case where the operator intends to keep storing the image data recorded in the recording medium and having the old recording date without compressing the data, there occurs a problem that the data is erased, resized or compressed. Moreover, to avoid the erasing, resizing and compressing, the operator has to protect the image data, and this requires a lot of trouble.

### BRIEF SUMMARY OF THE INVENTION

The present invention has the major characteristic that in a case where a remaining amount of a recording medium is reduced, image data to be erased, resized or compressed is automatically selected from image data recorded in the recording medium in accordance with the number of printing times, the number of digital copying times into another recording medium, or the number of times when a reduced image (thumbnail image) shifts to image data (main image) from which the reduced image is produced or in accordance with an accumulated weight value for the above number parameters made by weighting the number parameter and accumulating them.

One example of the present image data selecting method is as follows, the method comprises: recording captured image data and image data information on the image data, the image data information including times information containing at least one of the number of printing times based on the image data, the number of copying times of the image data, and the number of times when the reduced image of the image data is selected from a plurality of displayed reduced images and converted to the image data, wherein the times information is used for automatic selection of a image data for at least one of erasing, resizing, or compressing operation to secure an enough storage area.

When the at least one of erasing, resizing, or compressing operation is performed, it can be possible to display a plurality of reduced images selected based on the times information as candidates list before the operation.

It can further be possible that an operator select a reduced image from display of the plurality of reduced images to exclude a selected image from the operation object.

This invention can be understood as an invention of image data processing device that can perform the above method.

Also, this invention can be understood as an invention of image data structure, in which image data and image data information is contained. The image data information includes the times information described above.

According to the present invention, since the image data as the processing object to be erased, resized or compressed is automatically selected regardless of old or new image data, a necessary recording region can be secured without requiring any operator's trouble, and the image data can smoothly be continued to be recorded. The recording region can be secured regardless of the remaining amount of the recording medium. The image or the reduced image of the selected image data is displayed. After the operator confirms the display, the processing is executed. Therefore, the processing object image can be confirmed beforehand, and erroneous processing of the necessary image data is prevented.

### BRIEF DESCRIPTION OF THE SEVERAL VIEWS OF THE DRAWINGS

These and other features, aspects, and advantages of the apparatus and methods of the present invention will become better understood with regard to the following description, appended claims, and accompanying drawings where:

FIG. 1 is a block diagram showing a main part of a digital camera as one example of an image data processing device;

FIG. 2 is a diagram showing a digital camera which is connected to a printer device without interposing any personal computer in Example 1 of the present invention;

FIG. 3 is a block diagram showing a main part of a printer device in Example 1 of the present invention;

FIG. 4 is an explanatory view showing a recording region of data of a recording medium in the digital camera of Example 1 of the present invention;

FIG. 5 is a flow chart showing data processing in Example 1 of the present invention;

FIG. 6 is a flow chart showing data processing in Example 1 of the present invention;

FIG. 7 is a diagram showing a digital camera connected to a personal computer in Example 2 of the present invention;

FIG. 8 is a flow chart showing data processing in Example 2 of the present invention;

FIG. 9 is a flow chart showing data processing in Example 2 of the present invention;

FIG. 10 is a diagram showing a printer device connected to a personal computer in Example 3 of the present invention;

FIG. 11 is a diagram showing connection of a digital camera to the personal computer and a file constitution in a hard disk of the personal computer in Example 3 of the present invention;

FIG. 12 is a flow chart showing data processing in Example 3 of the present invention;

FIG. 13 is a flow chart showing data processing in Example 3 of the present invention;

FIG. 14 is a flow chart showing data processing in Example 3 of the present invention;

FIG. 15 is an explanatory view showing shift from a thumbnail display to a main image display in Example 4 of the present invention;

FIG. 16 is a flow chart showing data processing in Example 4 of the present invention;

FIG. 17 is a flow chart showing data processing in Example 4 of the present invention;

FIG. 18 is a diagram showing one example of weighting of the number of copying times, the number of printing times, or the number of times to shift from thumbnail to main image in Example 5 of the present invention;

FIG. 19 is a diagram showing a weighted addition example in Example 5 of the present invention;

FIG. 20 is a flow chart showing data processing in Example 5 of the present invention;

FIG. 21 is a diagram showing one example of a weighted added value obtained by weighting and adding up the number of copying times, the number of printing times, or the number of times to shift from thumbnail to main image in Example 6 of the present invention;

FIG. 22 is a diagram showing a remaining amount of a recording medium before and after memory secure processing in Example 6 of the present invention;

FIG. 23 is a flow chart of data processing in Example 6 of the present invention;

FIG. 24 is an explanatory view showing a batch display of thumbnail images of data as an erasing object in Example 7 of the present invention;

FIG. 25 is an explanatory view showing an emphasized display state of a frame of the thumbnail images of the data as the erasing object in Example 7 of the present invention;

FIG. 26 is a flow chart of data processing in Example 7 of the present invention;

FIG. 27 is an explanatory view showing a recording region of data of a recording medium in Example 8 of the present invention;

FIG. 28 is a flow chart of data processing in Example 8 of the present invention;

FIG. 29A is a diagram showing print history information as of May 31, 2003, stored in an image importance management degree file of a digital camera in one example of data stored in the image importance degree management file in Example 9 of the present invention;

FIG. 29B is a diagram showing print history information as of Dec. 30, 2003, stored in an image importance management degree file of a digital camera in one example of data stored in the image importance management degree file in Example 9 of the present invention;

FIG. 29C is a diagram showing print history information as of Dec. 30, 2003 of an image importance degree management file of a personal computer in one example of data stored in the image importance degree management file in Example 9 of the present invention; and

FIG. 29D is a diagram showing print history information synthesized and updated as of Dec. 30, 2003 in one example of data stored in the image importance degree management file in Example 9 of the present invention.

### DETAILED DESCRIPTION OF THE PREFERRED EMBODIMENTS

A preferred embodiment of the invention is described below with reference to the accompanying drawings.

In the present invention, when a remaining amount of a recording medium is reduced, a degree of importance of image data is automatically detected based on history of operation or processing performed with respect to each image data, and image data as an object to be erased, resized or compressed is automatically selected. Moreover, a thumbnail image is displayed before resize, compression or erase processing, and the processing is executed to secure a necessary storage region after an operator confirms the display. An outline of each example of the present invention is as follows.

In Example 1, a digital camera is connected to a printer device without interposing any personal computer, and image data to be erased is automatically selected in accordance with the number of printing times in the printer device.

In Example 2, a digital camera is connected to a personal computer, and data to be erased is automatically selected in accordance with the number of times of copying to another recording medium.

In Example 3, in a case where connection is changed to connection of a digital camera to a printer device, the digital camera to a personal computer, the personal computer to the printer device, and the digital camera to the personal computer in order to perform an operation, image data to be erased is automatically selected in accordance with the total number of printing times in the printer device.

In Example 4, data to be erased is automatically selected in accordance with the number of times (the number of times to shift from thumbnail to main image) when a thumbnail image shifts to a main image in a reproduction mode.

In Example 5, the number of printing times, the number of copying times, or the number of times to shift from thumbnail to main image is weighted, and times information is added up in accordance with the weighting to automatically select image data to be erased.

In Example 6, the number of printing times, the number of copying times and the number of times to shift from thumbnail to main image are weighted and added up to automatically select image data to be compressed, resized or erased in accordance with the resulting weighted added value. On the other hand, ranges or contents of a processing object are selected.

In Example 7, regardless of a remaining amount of a recording medium, image data regarded as an object by an operator is automatically selected, and compressed, resized or erased.

In Example 8, instead of automatically erasing data F as an erasing object automatically selected and determined in accordance with the number of printing times, the number of copying times, or the number of times to shift from thumbnail to main image, an operator is requested to judge whether or not to perform an erasing operation.

In Example 9, a digital camera is connected to a personal computer to notify the personal computer of identification information such as a serial number of the camera, printing date information, copying date information, and information on date to shift from thumbnail to main image.

### EXAMPLE 1

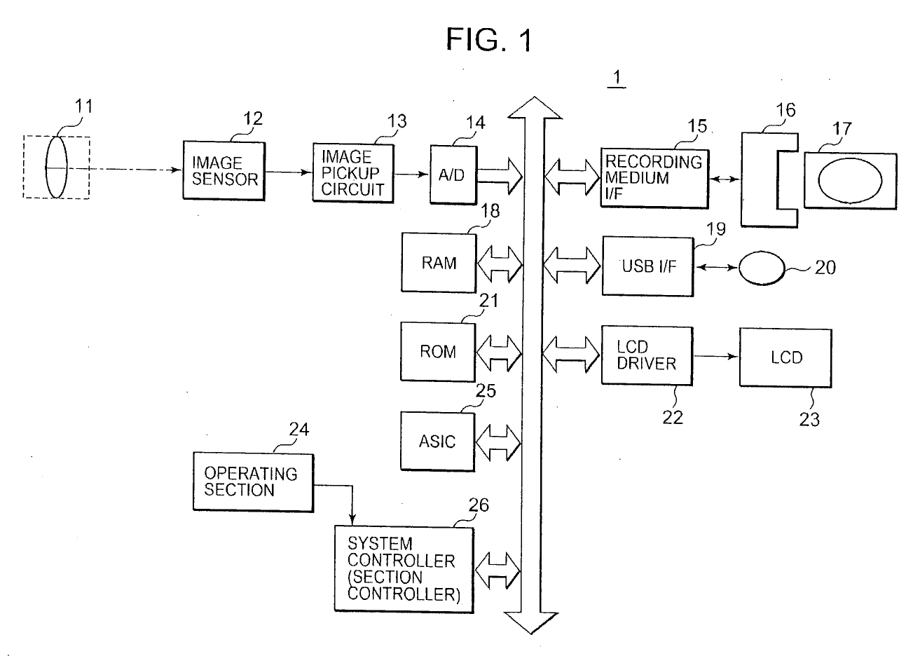

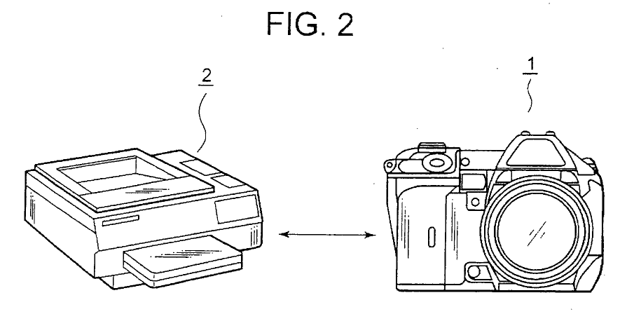

Example 1 of the present invention will be described with reference to FIGS. 2 to 6 in addition to FIG. 1. In Example 1, a digital camera is connected to a printer device without interposing any personal computer or the like therebetween, and image data to be erased is automatically selected in accordance with the number of printing times in the printer device. FIG. 1 shows a block diagram of a main part of a digital camera as one example of an image data processing device, and the diagram is applied in common to the examples of the present invention. FIG. 2 shows a digital camera 1 directly connected to a printer device 2 via a USB interface (USB I/F) or a USB terminal without interposing any personal computer therebetween. Image data stored in a recording medium 17 attached to the digital camera 1 is printed by the printer device 2, when the digital camera 1 is operated.

That is, when an operator operates an operating section 24 of the digital camera 1, and selects image data to be printed from image data stored in the recording medium 17 to give a printing instruction, the selected image data is stored in an RAM 18 from the recording medium 17 via a recording medium holding section 16 and a recording medium I/F 15. The image data stored in the RAM 18 of the digital camera 1 is transferred to the printer device 2 via a USB I/F 19 and a USB terminal 20, and printed. It is to be noted that an operation input to perform the printing may be performed on the side of the printer device 2.

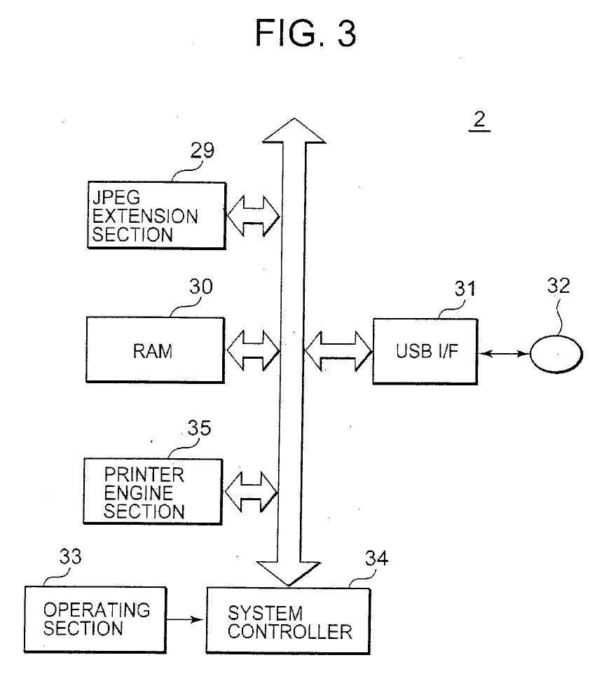

FIG. 3 shows a block diagram of a main part of the printer device 2. A JPEG extension section 29, an RAM 30, a USB I/F 31, a system controller 34 and a printer engine section 35 are connected to one another by a bus. The image data transferred to the printer device 2 is stored in the RAM 30 of the printer device 2 via a USB terminal 32 and the USB I/F 31. The image data transferred from the digital camera 1 to the printer device 2 is extended by the JPEG extension section 29, extended data is stored again in the RAM 30, and the image data is converted into printing data by the printer engine section 35, and printed.

It is to be noted that the number of sheets to be printed, a type of the printing sheet, a printing density and the like are set by operating an operating section 33 of the printer device 2, and constituting elements of the printer device 2 are controlled by the system controller 34 to function. This number of the sheets to be printed may be set by the operating section 24 of the digital camera 1, and this also applies to the type of the printing sheet, the printing density and the like.

When the printing by the printer device 2 ends, a printing completion signal sent from the printer device 2 is detected by a system controller 26 of the digital camera 1, and a management data region such as a header or a footer of the image data printed by the printer device 2 is accessed.

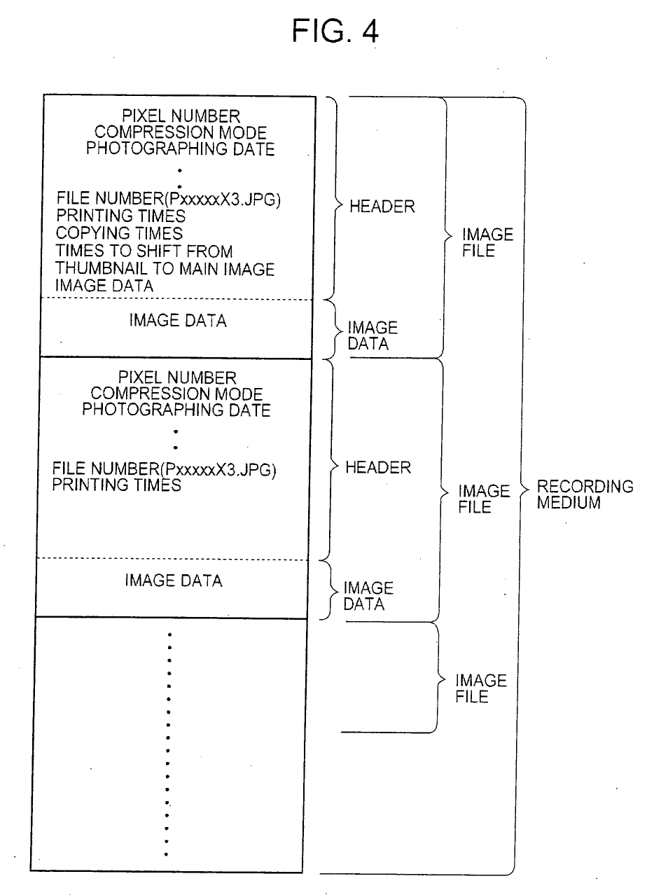

FIG. 4 shows a recording mode of the image data in the recording medium 17 disposed in the digital camera 1. As seen from FIG. 4, a plurality of sheets of image data can be recorded as an image file of a file form in the recording medium. A management data such as a header or a footer (not shown) in each image file includes a printing times storage region to record the number of the printing times in the printer device in response to an instruction from the digital camera or the printer device. In FIG. 4, this printing times storage region is disposed in the header. The image file is constituted by including and combining the image data and a header section to store information of this image data. In this header, in addition to the number of the printing times, there are stored pixel number information, compression mode information indicating a compression degree of the image data, photographing date information and file number information as the information of the image data. Furthermore, there may be stored photographing information such as a shutter speed and exposure correction in a case where the photographing is performed. In addition to the file number information, it is possible to store ID information constituted of, for example, character information by which the image data can be identified. During a printing operation, the number of the printing times recorded in the header as the management data region is read by the RAM 18. After adding one to the number, the number is overwritten and stored again in the printing times storage region of the management data region. It is to be noted that during the addition to the number of the printing times accompanying the printing operation, the number corresponding to the number of the printed sheets is added, but one may be added per one printing instruction regardless of the number of sheets instructed to be printed once.

In a photographing operation, the recording medium 17 of the digital camera 1 is accessed at a timing such as a start timing of a photographing mode, and a remaining amount of the recording medium is checked. In a case where the remaining amount of the recording medium is larger than a minimum of one picture photographable at a time when the remaining amount of the recording medium 17 is checked, the operation instantly shifts to the photographing operation.

Here, when the checked remaining amount of the recording medium 17 is smaller than one photographable picture, the data is erased from the recording medium 17, and it is necessary to produce a recording region where photographing of one picture is possible. In a case where the system controller 26 detects that the checked remaining amount of the recording medium 17 is smaller than one photographable picture, a warning to this effect is displayed in an LCD 23. When a processing start button (not shown) disposed in the operating section 24 of the digital camera 1 is pressed in response to the warning display, a processing start signal is generated, and the generation of the processing start signal is detected by the system controller 26. In this case, the system controller 26 accesses the management data regions of all the image files recorded in the recording medium 17, and printing times information and the ID information such as a file number of the image data are read out to the RAM 18. Moreover, when the number of the printing times is large, the image data is repeatedly printed. Therefore, a necessity of storing the image data is judged to be small, and the readout image data (image file) having the largest number of the printing times is erased from the recording medium 17 under the control of the system controller 26. It is to be noted that in a case where the system controller 26 detects that the checked remaining amount of the recording medium 17 is smaller than one photographable picture, the processing start button does not have to be pressed, and the processing operation may automatically be started. In this case, the warning is not displayed, processing start is displayed, and the processing may be started as it is.

When the erasing of the image data of the recording medium 17 is completed, the remaining amount of the recording medium is checked again. When the checked remaining amount of the recording medium is larger than a data amount per picture in the photographing mode, the operation shifts to the photographing operation. When the checked remaining amount of the recording medium is small, the above erasing operation is repeated until the data amount for one picture is secured.

As shown in FIG. 4, the number of the printing times is recorded in the image file, but additionally the image data information concerning the image data, such as the number of pixels, the photographing mode, a photographing date and the file number concerning the image data are combined with the image data to form one piece of image information in the form of the image file. When the image data and the image data information are combined to form image information such as one image file in this manner, the data can be handled every minimum unit, that is, every image file, and data management is facilitated.

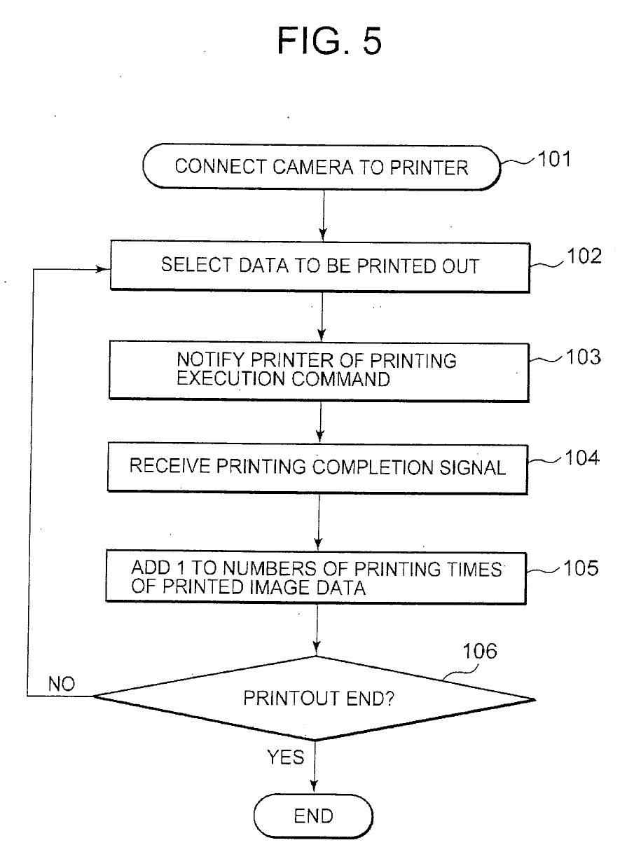

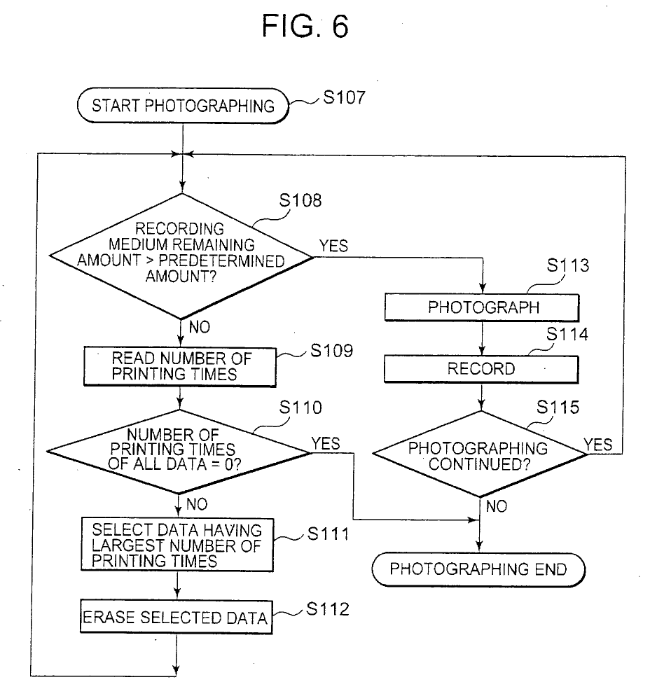

FIGS. 5, 6 show flow charts of data processing in a case where the digital camera 1 is connected to the printer device 2, and the image data to be erased is automatically selected in accordance with the number of the printing times. FIG. 5 shows a flow on the side of the digital camera 1 during the printing operation. As shown in FIG. 2, the USB terminal 20 of the digital camera 1 is connected to the USB terminal 32 of the printer device 2 by a cable, and the digital camera 1 is directly connected to the printer device 2 without interposing any personal computer therebetween (S101).

The operator operates the operating section 24 of the digital camera 1, and selects the image data to be printed from the image data displayed in the LCD 23 (S102). Furthermore, the operator operates the operating section 24 of the digital camera 1, and notifies the printer device 2 of a printing command to execute the printing (S103). The number of the sheets to be printed is initially set to one. When two or more sheets are printed, the operating section 24 of the digital camera 1 is operated to change the number of the sheets to be printed. When the operation of printing the predetermined number of the sheets is executed and completed, the system controller 34 of the printer device 2 sends a printing completion signal to the digital camera 1, and the system controller 26 of the digital camera 1 receives this signal to end the printing operation (S104).

When the printing operation of the printer device 2 ends, the printing completion signal sent from the printer device 2 is received by the system controller 26 of the digital camera 1, and a management data region such as the header or the footer of the image data printed by the printer device 2 is accessed. Moreover, the number of the printing times is read out to the RAM 18 from the printing times storage region of the management data region of the data. In a case where the number of the printed sheets is one, after adding one, the number is overwritten and stored again in the printing times storage region of the recording medium 17 (S105). In the present example, the number of the printed sheets is added as the number of the printing times. Therefore, when the number of the printed sheets is, for example, three, three is added. It is to be noted that regardless of the number of the printed sheets, only one may be added per printing start instruction.

To continue the printing operation, the flow returns to S102 to select the image data to be printed and repeat the printing operation. When the printing operation is not continued, the flow ends (S106).

Next, the flow will be described with reference to FIG. 6. FIG. 6 shows a processing flow of automatic selecting and erasing of the image data during the photographing. The operator operates the operating section 24 of the digital camera 1 to start the photographing (S107). The system controller 26 accesses the recording medium 17 of the digital camera 1, and checks the remaining amount of the recording medium (S108). In a case where the remaining amount of the recording medium is larger than a minimum of one photographable picture (predetermined value) in the photographing mode at that time, the operation shifts to the photographing operation (S113). The photographing operation is performed to record the image data in the recording medium 17 (S114). When the photographing is not continued, the photographing ends. To continue the photographing, the flow returns to S108 (S115).

When the checked remaining amount of the recording medium 17 is smaller than an amount required for photographing and recording one picture, the management data regions of all the image files recorded in the recording medium 17 are accessed, and the number of the printing times is read into the RAM 18 (S109). If the number of the printing times of all the image data is all zero, a degree of importance of the image data as an erasing object cannot be compared or judged. Since the remaining amount of the recording medium 17 is running short, it is indicated with respect to the operator that the photographing cannot be performed, thereby ending the flow. During the indicating, this effect may be displayed on, for example, the LCD 23. If the number is not zero, the image data having the largest number of the printing times is automatically selected (S111), the selected image data is erased (S112), and the recording region where the photographing of one picture is possible is-produced to return to S108.

At this time, in a case where there exist a plurality of, for example, two image data having the largest number of the printing times, all the plurality of data may be selected and erased. In this case, since a recording capacity corresponding to a capacity of the plurality of erased data is produced, the photographing of not only one picture but also the plurality of pictures might newly be performed. Alternatively, the image data having the old date is preferentially selected from the plurality of image data, and the only old image data may be erased.

It is to be noted that as a case where the degree of importance of the image data as the erasing object cannot be compared or judged, there has been described a case where the number of the printing times of all the image data is zero. For example, even in a case where all the image data have the equal number of the printing times, processing may be performed in the same manner as described above. Alternatively, in the case where all the image data have the equal number of the printing times, the data having the old date may preferentially be selected in the same manner as in the case where there exist a plurality of, for example, two image data having the largest number of the printing times.

In Example 1, when the remaining amount of the recording medium 17 comes short in this manner, the image data having the largest number of the printing times is automatically selected and erased to thereby produce the recording region. The image data as an erase processing object is automatically selected in accordance with the degree of importance of the image, regardless of whether or not the image data is new. Therefore, it is possible to secure a necessary recording region without requiring an operator's trouble of protecting a desired image beforehand, and the recording of the image data can smoothly be continued.

### EXAMPLE 2

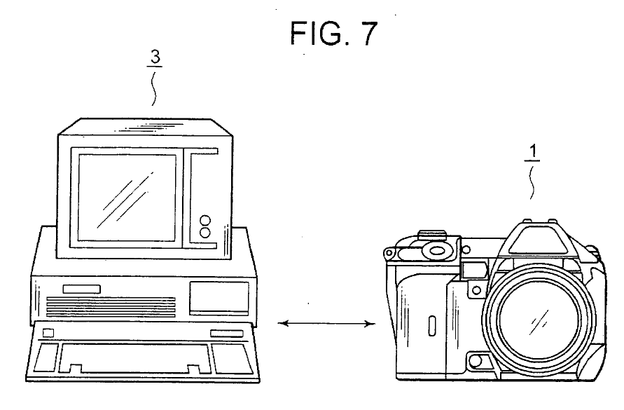

In Example 2, a digital camera is connected to a personal computer, and image data to be erased is automatically selected in accordance with the number of copying times with respect to a recording medium of the personal computer. FIG. 7 shows a digital camera 1 connected to a personal computer 3 via a USB I/F and a USB terminal. Example 2 will be described with reference to FIGS. 1 and 7 to 9.

An operator selects the image data to be copied from image data stored in a recording medium 17 in order to copy the image data stored in the recording medium 17 of the digital camera 1 into the personal computer 3. Moreover, the selected image data (image file) is stored in a RAM 18 from the recording medium 17 via a recording medium I/F 15. The stored image data is transferred to the personal computer 3 and copied into the recording medium of the personal computer 3 via a USB I/F 19 and a USB terminal 20. The selecting operation and a copying start instruction are performed on the side of the digital camera 1, but may be performed on the side of the personal computer 3.

When the copying operation into the personal computer 3 ends, a copying completion signal sent from the personal computer 3 is received by a system controller 26 of the digital camera 1. A management data region such as a header or a footer of the image file includes a copying times storage region to record information on the number of the copying times into the personal computer 3. The number of the copying times recorded in this management data region is read out into the RAM 18. In response to the detection of the copying completion signal sent from the personal computer 3 by the system controller 26 of the digital camera 1, one is added to the number. After the adding, the number is overwritten and stored again in the copying times storage region of the management data region.

When the operator starts a photographing operation, first the recording medium 17 of the digital camera 1 is accessed to check a remaining amount of the recording medium. When the remaining amount of the recording medium is larger than a minimum of one picture photographable in a photographing mode at the checking time, the operation shifts to the photographing operation. When the remaining amount of the recording medium 17 is smaller than one photographable picture, management data regions such as headers or footers of all the image files recorded in the recording medium are accessed, copying times information and ID information such as a file number are read out into the RAM 18, and the image data having the largest number of the copying times is automatically selected and erased from the recording medium. Here, when the number of the copying times is large, there are a large number of copies. Therefore, it is judged that a necessity of storing original image data is small. When the copy is a digital copy, the same data as the original data remains. Therefore, it is considered that even if the original data is erased, there is not any problem.

When the erasing is completed, the remaining amount of the recording medium 17 is checked again. Moreover, when the remaining amount of the recording medium 17 is larger than a data amount (data amount for one picture to be photographed, storage region) of data required for the photographing mode, the operation shifts to the photographing operation. When the remaining amount of the recording medium is small, the erasing of the image data is repeated until the data amount for one picture is secured. When the necessary data amount is secured, the operation shifts to the photographing operation.

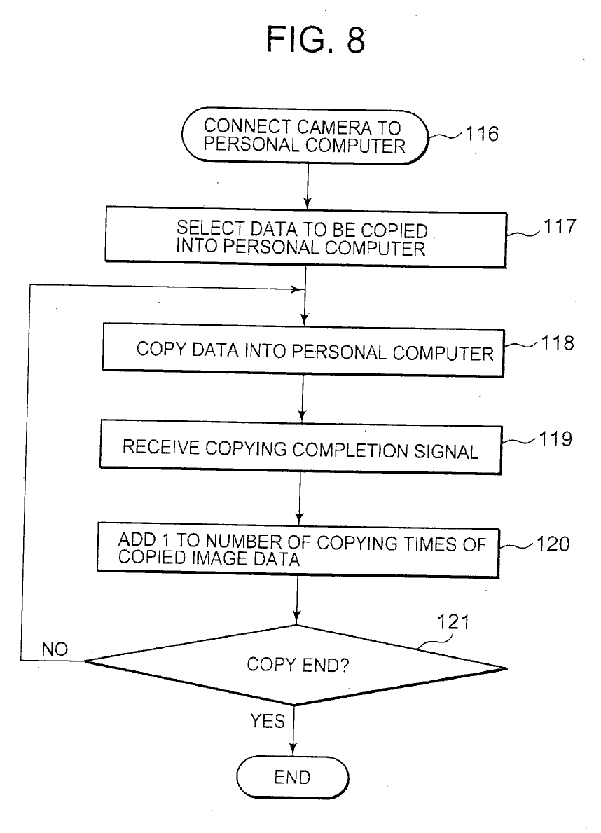

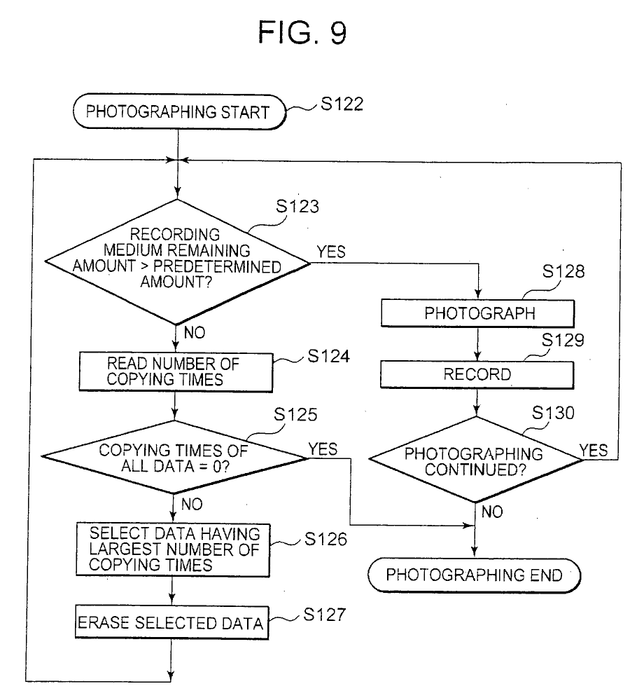

FIGS. 8 and 9 show flow charts showing data processing to automatically select the data to be erased in accordance with the number of the copying times. FIG. 8 shows an operation flow in the digital camera 1. First, the flow will be described with reference to FIG. 8. The digital camera 1 is connected to the personal computer 3 via the USB I/F 19 and the USB terminal 20 (S116). Moreover, an operating section 24 of the digital camera 1 is operated to select the data to be copied into the personal computer 3 from the data recorded in the recording medium 17 of the digital camera 1. The selected data is stored in the RAM 18 from the recording medium 17 via the recording medium I/F 15 (S117).

When the selection of the image data ends, the operating section 24 is operated to instruct execution of the copying. In response to this instruction, the digital camera 1 notifies the personal computer 3 of a copy execution command, and the data of the RAM 18 is transferred to the personal computer 3 via the USB I/F 19 and the USB terminal 20, and copied into the recording medium of the personal computer 3 (S118). When the copying operation is completed, the copying completion signal is output from the personal computer 3. When the system controller 26 of the digital camera 1 receives the copying completion signal (S119), a management data region such as the header or the footer of the corresponding image data of the recording medium 17 disposed in the digital camera 1 is accessed. The number of the copying times recorded in the management data region of the image file is read out into the RAM 18. After adding one to the number, the number is overwritten and stored in the copying times storage region of the management data region (S120). Subsequently, the operator determines whether or not to end the copying operation (S121). To end the copying operation, the digital camera 1 is disconnected from the personal computer 3 to end the operation. To continue the operation (to copy another data), the flow returns to S117 to repeat the copying operation into the personal computer 3.

Next, the flow will be described with reference to FIG. 9. FIG. 9 shows a processing flow of automatic selecting and erasing of the image data during the photographing operation. The operator operates the operating section 24 of the digital camera 1 to start the photographing (S122). The system controller 26 accesses the recording medium 17 of the digital camera 1 to check the remaining amount of the recording medium (S123). In a case where the remaining amount of the recording medium 17 is larger than one picture (predetermined value) which is photographable in the photographing mode at that time, the operation shifts to the photographing operation (S128). The photographing operation is performed to record the image data in the recording medium (S129). The operator determines whether or not to continue the photographing (S130). When it is determined that the photographing is not continued, the photographing is ended. To continue the photographing, the flow returns to S123.

When the checked remaining amount of the recording medium 17 is smaller than a predetermined amount required for photographing and recording one picture, the management data regions of all the image files recorded in the recording medium 17 are accessed, and the number of the copying times is read into the RAM 18 (S124). It is judged whether or not the number of the copying times of all the image data is zero (S125). If the number is zero, a degree of importance of the image data as an erasing object cannot be compared or judged. Since the remaining amount of the recording medium 17 is running short, it is indicated with respect to the operator that the photographing cannot be performed, thereby ending the flow. If the number is not zero, the image data having the largest number of the copying times is automatically selected (S126), and erased (S127), thereby returning to S123.

At this time, in a case where there exist a plurality of, for example, two image data having the largest number of the copying times, all the plurality of data may be selected and erased. In this case, since a recording capacity corresponding to a capacity of the plurality of erased data is produced, the photographing of not only one picture but also the plurality of pictures might newly be performed. Alternatively, the image data having the old date is preferentially selected from the plurality of image data, and the only old image data may be erased.

It is to be noted that as a case where the degree of importance of the image data as the erasing object cannot be compared or judged, there has been described a case where the number of the copying times of all the image data is zero. For example, even in a case where all the image data have the equal number of the copying times, processing may be performed in the same manner as described above. Alternatively, in the case where all the image data have the equal number of the copying times, the data having the old date may preferentially be selected in the same manner as in the case where there exist a plurality of, for example, two image data having the largest number of the copying times.

Even in a case where the flow returns to S123 to check the remaining amount of the recording medium 17 again, when the remaining amount is smaller than the amount required for photographing one picture, and the number of the copying times of all the image data is not zero, the data having the second largest number of the copying times is selected and erased. The image data is similarly selected and erased in order from the larger number of the copying times until the remaining amount of the recording medium 17 becomes larger than the predetermined value.

Thus, in Example 2, when the remaining amount of the recording medium 17 comes short, the image data having the largest number of the copying times is automatically selected and erased to thereby produce the recording region. The image data as an erase processing object is automatically selected in accordance with the degree of importance of the image, regardless of whether or not the image data is new. Therefore, it is possible to secure a necessary recording region without requiring an operator's trouble of protecting a desired image beforehand, and the recording of the image data can smoothly be continued.

### EXAMPLE 3

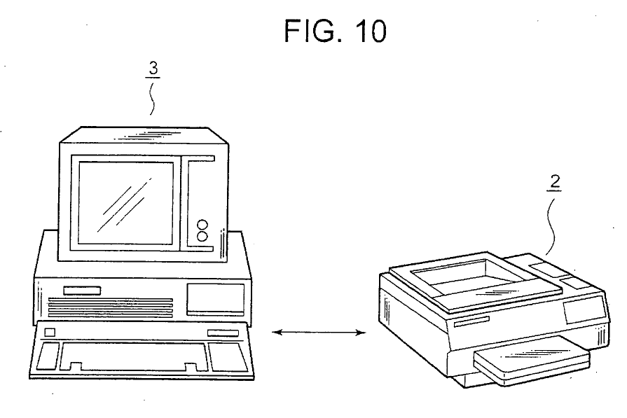

In Example 3, in a case where connection is changed to connection of a digital camera to a printer device, the digital camera to a personal computer, the personal computer to the printer device, and the digital camera to the personal computer in order to perform an operation, image data to be erased is selected in accordance with the number of printing times in the printer device. Example 3 will be described with reference to mainly FIGS. 10 to 14 in addition to FIG. 1.

A digital camera 1 is connected to a personal computer 3, and image data is copied from the digital camera into the personal computer. Since the copying of the data into the personal computer by the connection of the digital camera to the personal computer is similar to Example 2 (see FIGS. 7 to 9), description thereof is omitted.

After detaching a connecting cable connecting a USB terminal 20 of the digital camera 1 to a USB terminal (not shown) of the personal computer 3 to disconnect the digital camera 1 from the personal computer 3, as shown in FIG. 10, the personal computer 3 is directly connected to a printer device 2 via a USB I/F and a USB terminal. Here, printing is performed in the printer device 2 by use of the image data (image file) copied from a recording medium 17 of the digital camera 1 into the personal computer 3.

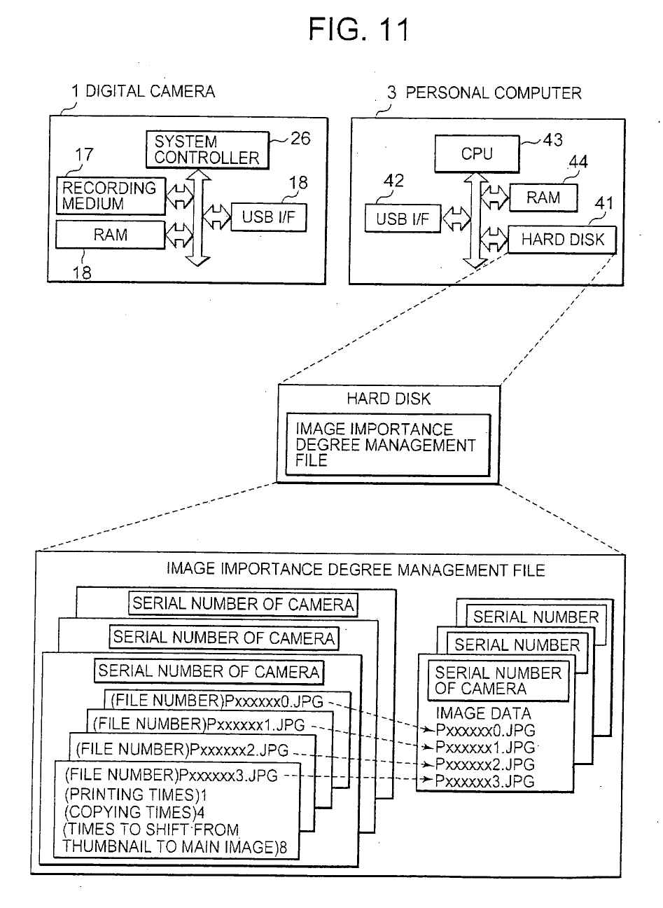

FIG. 11 shows a block diagram of a main part of the digital camera 1 and the personal computer 3, and a recording mode of data recorded in a hard disk 41 of the personal computer 3. The hard disk 41, a USB interface (USB I/F) 42, a CPU 43 and a RAM 44 are connected to one another by a bus. The number of printing times of image data printed by the printer device 2 is stored in an image importance degree management file recorded in the hard disk 41 of the personal computer 3.

That is, first the digital camera 1 is connected to the personal computer 3 via a USB I/F 19 and the USB I/F 42, and the image data (image file) of the digital camera 1 is copied into the personal computer 3. In the image importance degree management file of the hard disk 41 of the personal computer 3, there are stored: camera identification information constituted of ID information such as a serial number of the connected digital camera; and image file ID information such as a file number of the copied image data (image file), which correspond to management information on the copied image data. The camera identification information constituted of ID information such as the serial number of the digital camera is stored in an ROM 21 of the digital camera 1.

Next, the connecting cable connecting the digital camera 1 to the personal computer 3 via the USB I/Fs 19, 42 is detached to disconnect the camera from the personal computer. As shown in FIG. 10, the personal computer 3 is connected to the printer device 2. Moreover, an operation is started to print the image data copied from the digital camera 1 to the personal computer 3. That is, instead of the image data in the recording medium 17 of the digital camera 1, the printing is performed based on this image data in the personal computer 3 into which the image data has been copied. When the copy is a digital copy, the same printing result is obtained even based on either of the image data.

When the printing operation is completed, printing times information of the printed image data is searched from the image importance degree management file, and the number of the printing times of the image data is read out into the RAM 44 of the personal computer. In a case where the number of the printed sheets is one, after adding one to the number, the number is overwritten and stored again in a printing times storage region of the image importance degree management file. In the present example, the number of the printed sheets is added as the number of the printing times. Therefore, when the number of the printed sheets is, for example, three, three is added. It is to be noted that regardless of the number of the printed sheets, only one may be added per printing start instruction.

The personal computer 3 is disconnected from the printer device 2, and the personal computer 3 is again connected to the digital camera 1. After the connecting, the digital camera 1 notifies the personal computer 3 of the camera identification information constituted of ID information such as the serial number of the digital camera 1. When the personal computer 3 receives the camera identification information constituted of ID information such as the serial number of the digital camera 1, it is judged whether or not there is the notified camera identification information in the image importance degree management file. That is, the serial number of the digital camera functions as the camera identification information by which a connected device is recognized and identified.

When the presence of the camera identification information of the connected digital camera is detected, ID information such as the file number of the image file sent from the digital camera 1 is searched from the image importance degree management file, the printing times information of each corresponding image file is read out into the RAM 44, and the readout printing times information corresponding to each image file is transmitted to the digital camera 1. When a system controller 26 of the digital camera 1 receives the file number information and the printing times information transmitted from the personal computer 3, the printing times information of the file number notified from the personal computer 3 is searched from the image file stored in the recording medium 17.

The number of a printing times stored in the printing times storage region of a management data region such as a header or a footer of the image file corresponding to the file number notified from the personal computer 3 is read out into an RAM 18 of the digital camera 1. Moreover, after adding the number of the printing times notified from the personal computer 3, the number is overwritten and stored again in the printing times storage region of the management data region.

When rewriting (updating) of the number of the printing times in the digital camera 1 is ended, the digital camera 1 transmits a printing times information rewriting completion signal to the personal computer 3. On receiving the rewriting completion signal of the printing times information of the digital camera, the personal computer 3 resets the printing times information of each corresponding image file stored in the image importance degree management file of the hard disk 41 to rewrite the information to zero.

To further perform photographing and recording in the digital camera 1 disconnected from the personal computer 3, an operation is performed as shown in a flow chart of FIG. 6.

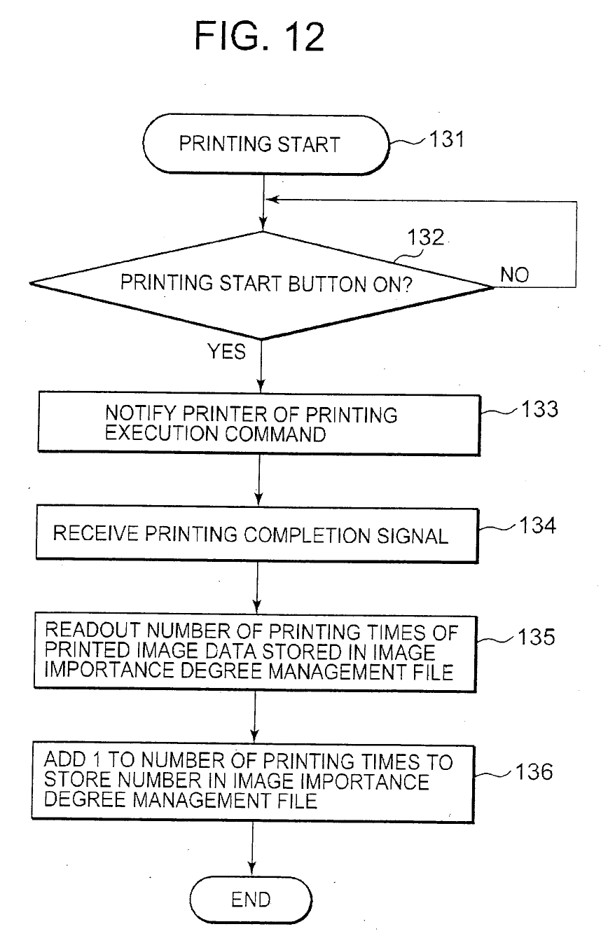

FIGS. 12, 13 and 14 show a flow chart of data processing in Example 3 in which in addition to the number of the printing times directly performed from the digital camera, the printing times information of the image data copied from the digital camera 1 into the personal computer 3 is also taken into consideration to select the image data to be erased.

The digital camera 1 is connected to the personal computer 3, the image data stored in the recording medium 17 of the digital camera 1 is copied into the personal computer 3, and the personal computer 3 is disconnected from the digital camera 1. Moreover, to print the image data copied from the digital camera 1 into the personal computer 3, the personal computer 3 is connected to the printer device 2 as shown in FIG. 10 to select the image data to be printed. FIG. 12 shows a flow chart on the side of the personal computer 3 in this case.

First, the printing operation is started by starting a printing mode or the like (S131), and the image data to be printed is selected from the image data recorded in the hard disk 41 of the personal computer 3. It is to be noted that the image data may be recorded in a portable recording medium such as an IC card which can detachably be connected to the personal computer 3. After the selection of the image data is completed, it is judged whether or not a printing start button is ON (S132). When the printing start button is pressed, the printer device 2 is notified of a printing execution command (S133). When the button is not pressed, a print waiting state is achieved, and the printer device is on standby. When the printer device 2 is notified of the printing execution command, and ends the printing operation, a printing completion signal is sent from the printer device 2 to the personal computer 3. When the personal computer 3 receives the printing completion signal (S134), the printing times information of the printed image data is read from the image importance degree management file stored in the hard disk 41 of the personal computer 3 (S135).

In a case where the number of the printed sheets is one, after adding one to the number of the printing times, the number of the printing times is overwritten and stored again in the printing times storage region of the image importance degree management file (S136), thereby ending the flow. To further continue the printing operation, the image data is selected again, and the printing start button is turned on again. It is to be noted that in the present example, the number of the printed sheets is added as the number of the printing times. Therefore, when the number of the printed sheets is, for example, three, three is added. It is to be noted that regardless of the number of the printed sheets, only one may be added per printing start instruction.

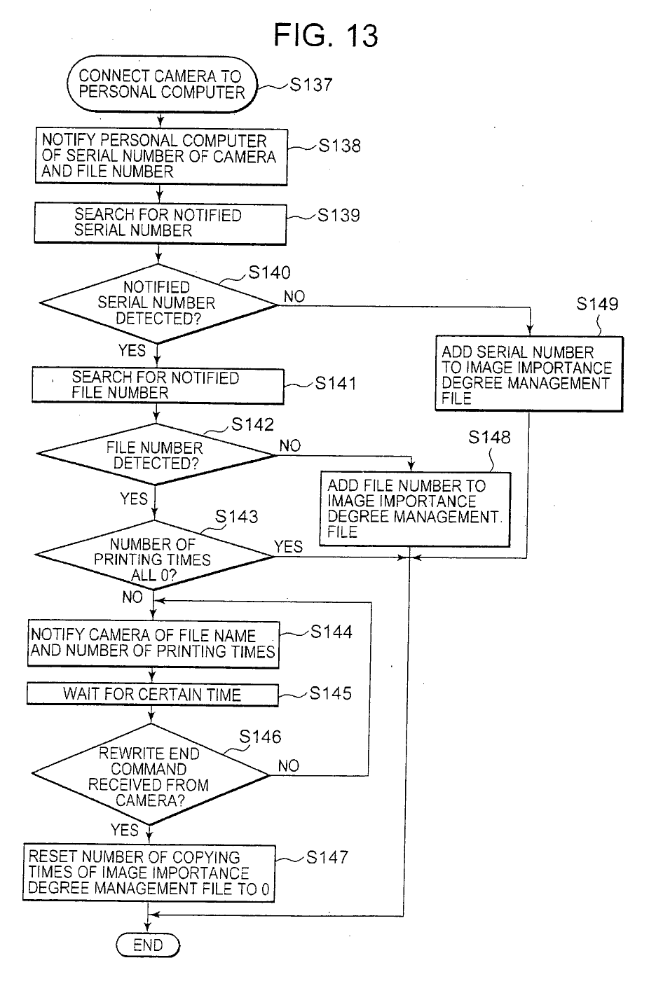

FIG. 13 is a flow chart showing data processing on the side of the personal computer 3 in a case where after connecting the personal computer 3 to the printer device 2 to perform the printing as shown in FIG. 12, the personal computer is disconnected from the device, and the digital camera 1 is connected to the personal computer 3 again as shown in FIG. 7.

First, the digital camera 1 is connected to the personal computer 3 by a cable via the USB I/Fs 19, 42 (S137). The ID information of the connected digital camera 1 is distinguished. In a case where ID of the digital camera 1 meets that of the information, to update the printing times information which is information of the image data, the personal computer 3 is notified of identification information such as the serial number of the connected digital camera 1, and image file ID information such as the file number of the image data recorded in the recording medium of the digital camera 1 (S138), and the presence of the notified serial number of the digital camera 1 is searched (S139). That is, it is judged whether or not the ID information of the corresponding camera is stored in the image importance degree management file of the hard disk 41 of the personal computer 3 (S140).

When ID information such as the serial number of the connected digital camera 1 is not detected, the digital camera 1 has not been connected to the personal computer 3 once. Therefore, ID information such as the serial number of the digital camera 1 that is not detected in S140 is newly added to and stored in the image importance degree management file of the hard disk 41 of the personal computer 3, thereby ending the flow (S149). It is to be noted that the ID information of the digital camera 1 that has not been connected may automatically be stored in the image importance degree management file of the personal computer 3 as shown in the flow chart of FIG. 13, or the information may newly be stored only in a case where the image data of the digital camera is instructed to be copied into the personal computer.

When ID information such as the notified serial number of the digital camera 1 is already stored in the image importance degree management file, image file ID information such as the notified file number of the image data is searched from a corresponding region (region of ID information of the digital camera 1 detected in S138) of the image importance degree management file (S141), and it is judged whether or not the file number is stored in the corresponding region of the image importance degree management file (S142). In a case where the file number of the data is not detected, and is not stored in the image importance degree management file, image file ID information such as the file number of the image data which is not detected in S142 is added to and stored in the region of image file ID information such as the serial number (of the image importance degree management file of the digital camera) detected in S138 (S148), thereby ending the flow.

When the notified file number of the image data is detected in the corresponding region (region of the ID information of the digital camera detected in S138) of the image importance degree management file (S142), the printing times information of the detected file number is read into the RAM 44, and it is judged whether or not the read number of the printing times is all zero (S143). If the read number of the printing times is all zero, the data is not printed directly from the personal computer 3. Therefore, there is not any change in the number of the printing times, and the flow ends as it is. If the number is not zero, the digital camera 1 is notified of the read number of the printing times together with the image file ID information (S144). Based on this notice, the printing times information stored in the recording medium 17 of the digital camera 1 is rewritten, the personal computer is on standby for a certain time until a rewrite completion signal is notified from the digital camera 1 (S145) . If the number of the printing times stored in the digital camera is, for example, four, and the number of the printing times notified from the personal computer to the digital camera is twice, the printing times information is rewritten into six that is the total number of the times.

It is judged whether or not the rewrite completion signal has been received from the digital camera 1 (S146). Even in a case where the personal computer is on standby for the certain time, if the signal is not detected, the flow returns to S144. If the signal is detected, the printing times information stored in the corresponding region of the image importance degree management file, that is, a region from which the printing times information has been sent to the digital camera 1 is reset and rewritten into zero (S147), thereby ending the flow.

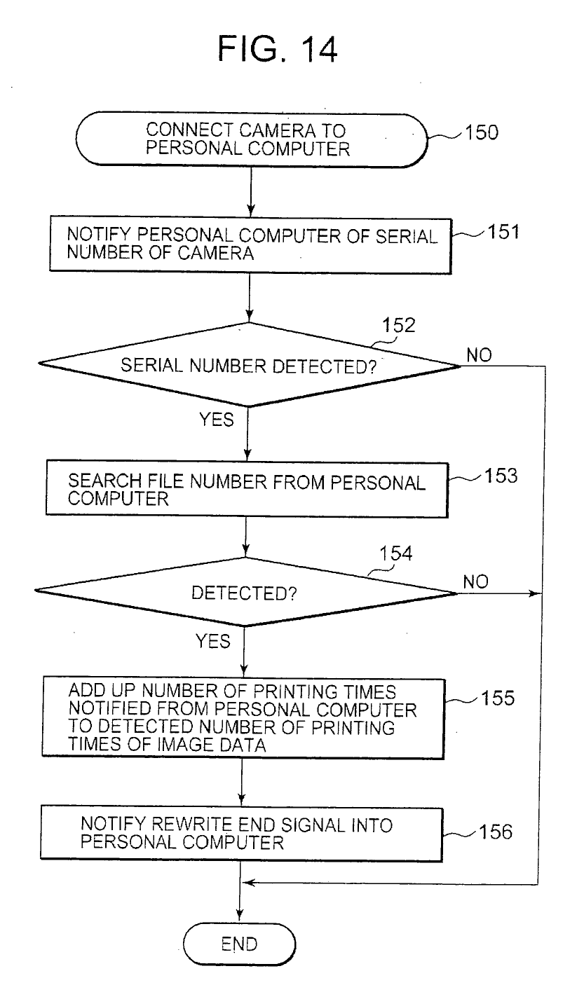

FIG. 14 shows a flow chart of data processing on the side of the digital camera in a case where after connecting the personal computer 3 to the printer device 2 to perform the printing as shown in FIG. 12, the personal computer is disconnected from the printer device, and the digital camera 1 is connected to the personal computer 3 again as shown in FIG. 7. The digital camera 1 is connected to the personal computer 3 by the cable via the USB I/Fs 19, 42 (S150). The personal computer 3 is notified of the ID information of the connected digital camera 1 (S151).

The notified ID information of the digital camera 1 is searched from the image importance degree management file in the hard disk 41 of the personal computer 3 to judge the presence of the information. If the information is present, the personal computer 3 notifies the digital camera 1 of this effect. If the information is not present, the flow ends as it is (S152). In response to this notification, the digital camera 1 transmits to the personal computer 3 the image file ID information of the image data recorded in the recording medium. It is judged that the notified image file ID information is present in the image importance degree management file of the hard disk 41 of the personal computer 3, and the printing times information is searched from the file (S153). As a result of the searching, in a case where the notified image file ID information is not present, or in a case where the image file ID information present, but the printing times information is zero, after disconnecting the personal computer 3 from the digital camera 1, the personal computer 3 is not connected to the printer device 2 to perform the printing. Therefore, since there is not any change in the printing times information stored in the recording medium of the digital camera 1, the flow ends as it is (S154).

In a case where in S154, there is detected the printing times information on the image file ID information, the detected printing times information is read out into the RAM 44, and sent to the digital camera 1 together with the image file ID information. The printing times information notified from the personal computer 3 is added to the printing times information of the corresponding image file in the recording medium 17 of the digital camera 1 (S155), and an addition result is overwritten and stored again as the printing times information in the recording medium 17. When the re-storing is completed, the personal computer 3 is notified of a rewrite end signal of the printing times information (S156), thereby ending the flow. On receiving this notification, the personal computer 3 resets the corresponding printing times information as shown in the flow chart of FIG. 13.

It is to be noted that in Example 3, in a case where the identification information of the digital camera 1 is used, and the ID information of the digital camera 1 agrees with that stored in the personal computer, it has been detected and confirmed that the image data held on the side of the personal computer is the image data copied from the digital camera 1. This identification information may be disposed every recording medium 17 such as the IC card detachably connected to the digital camera 1. According to this constitution, when the ID of the recording medium is matched, it can be judged that the image data has been copied from this recording medium. Therefore, it can be identified and distinguished more precisely and correctly than distinguished by each camera.

As to a method of automatically selecting the image data as an erasing object, even in Example 3, in a case where the number of the printing times is large, since the data is repeatedly printed, it is judged that a necessity of storing the image data is small in the same manner as in the Example 1. Moreover, when the remaining amount of the recording medium 17 comes short, the image data having the largest number of the printing times is automatically selected and erased to thereby produce a recording region, and the image data as an erase processing object is selected regardless of whether or not the image data is new. Therefore, it is possible to secure a necessary recording region without requiring any operator's trouble, and the recording of the image data can smoothly be continued.

### EXAMPLE 4

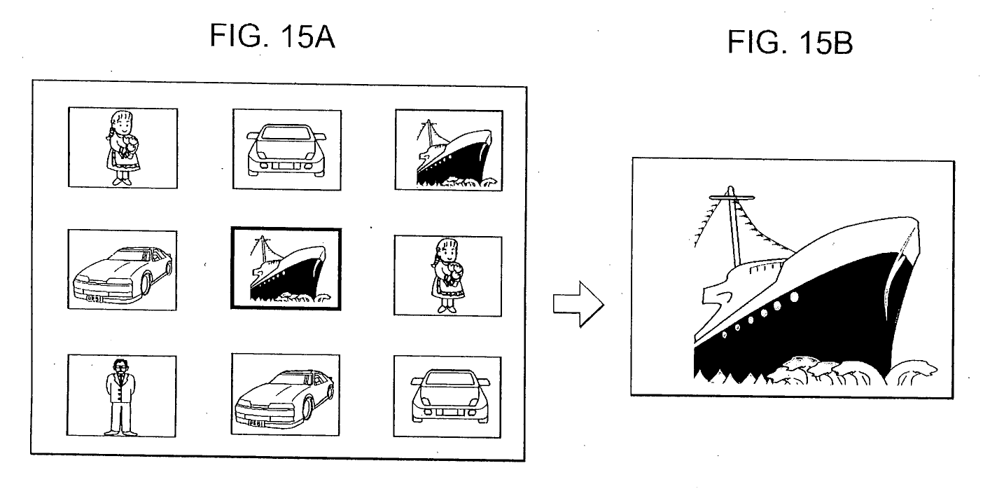

In Example 4, data to be erased is automatically selected in accordance with the number of times when display of reduced images produced based on image data shifts to display of image data before the selected reduced image is produced, that is, the number of times when thumbnail images shift to a main image in a reproduction mode. Example 4 will be described with reference to mainly FIGS. 15 to 17.

FIG. 15A shows one mode of a thumbnail display of an LCD 23 of a digital camera 1. In a case where an operator reproduces and browses desired images from a plurality of image data recorded in a recording medium 17 or an RAM 18 by photographing images, a mode of the digital camera 1 is set to the reproduction mode. As shown in FIG. 15A, an index reproduction mode is set in which a plurality of data are displayed as thumbnails in the LCD 23 to display an image group (target image group) to be browsed. Moreover, if a desired image to be reproduced is included in the group, for example, an image in the center of a second stage is selected as the desired image. Moreover, as shown in FIG. 15B, main image display is performed in which the only main image of the selected thumbnail image is displayed in the whole surface of the LCD 23 of the digital camera 1. The number of times (number of the times to shift from thumbnail to main image) when the thumbnail images shift to the main image is stored in a main image reproduction times storage region of a management data region such as a header or a footer of the image data subjected to the main image display (main image reproduction) (see FIG. 4).

That is, in a case where in the reproduction mode, the operator operates an operating section 24 to select the index reproduction mode in which a plurality of thumbnail images are displayed in the LCD 23, a system controller 26 detects that the index reproduction mode has been selected. The system controller 26 accesses the recording medium 17 or the RAM 18 to acquire thumbnail data of a plurality of image data to be displayed, or newly produces the thumbnail data. When the thumbnail data for performing the display can be prepared, an LCD driver 22 is controlled to display a plurality of thumbnail images in the LCD 23. The operator operates the operating section 24 to move a thick frame which encloses the thumbnail image as shown in, for example, FIG. 15A to a desired thumbnail image position, and selects an image to be enlarged to a full screen size and browsed from the plurality of thumbnail images displayed in the index reproduction mode. When a main image reproduction mode is set to display the only selected image data in the whole screen of the LCD 23, the system controller 26 detects that the main image reproduction mode has been selected, and the selected thumbnail image is reproduced as the main image.

When the selected image data shifts from the thumbnail images in the index reproduction mode to the main image in the main image reproduction mode, the number of the times to shift from thumbnail to main image stored in a storage region of the number of the times to shift from thumbnail to main image in a management data region such as the header or the footer of the image data selected and shifted to the main image is read out into the RAM 18. After adding one to the number, the number is overwritten and stored again in the storage region of the number of the times to shift from thumbnail to main image.

When the operator shifts to a photographing operation, first the system controller 26 accesses the recording medium 17 to check a remaining amount of the recording medium. In a case where the checked remaining amount of the recording medium is larger than a minimum of one picture photographable in a photographing mode at the time when the remaining amount of the recording medium 17 is checked, the photographing operation is continued. When the checked remaining amount of the recording medium is small, management data regions such as the headers or the footers of all the image data recorded in the recording medium are accessed, and the number of the times to shift from thumbnail to main image is read out into the PAM 18. Moreover, data having the read smallest number of the times to shift from thumbnail to main image is erased. Here, when the number of the times to shift from thumbnail to main image is small, it is judged that the main image is an image having little history as a browsing object and having a small degree of importance, and a necessity of storing original image data is small.

When the erasing is completed, the remaining amount of the recording medium 17 is checked again. When the checked remaining amount of the recording medium is larger than a data amount for one photographable picture, the operation shifts to the photographing operation. When the checked remaining amount of the recording medium is small, the erasing operation is repeated.

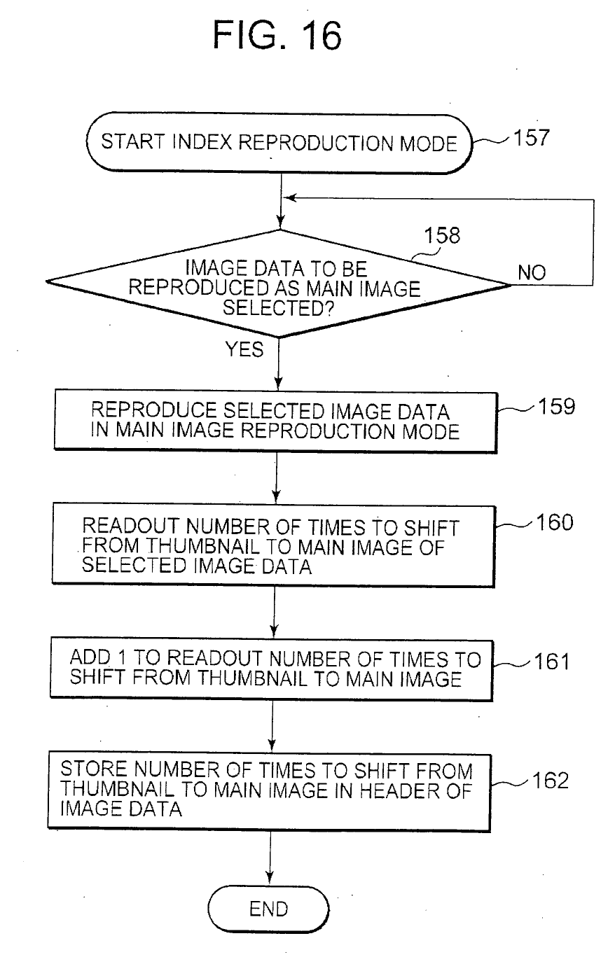

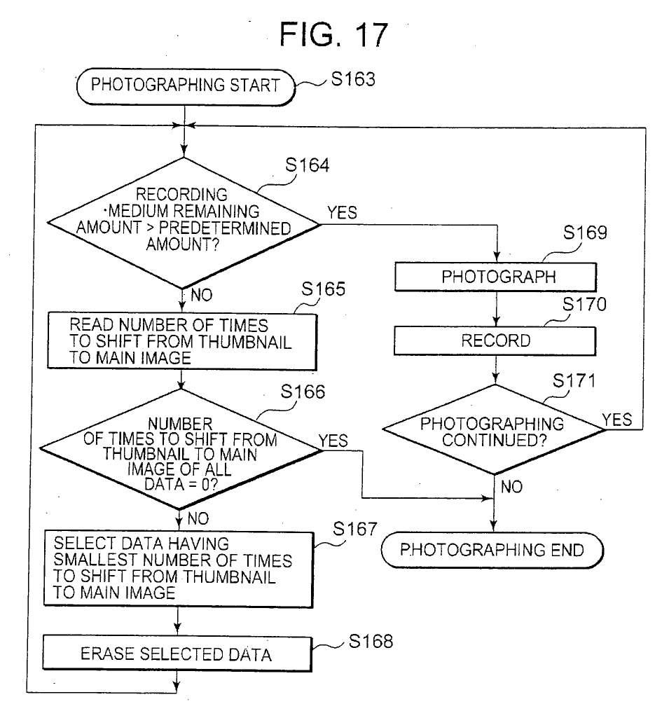

FIGS. 16, 17 show flow charts in a case where the number of the times to shift from thumbnail to main image in the reproduction mode is stored, and the image data having the smallest number of the times to shift from thumbnail to main image is erased.

FIG. 16 shows a flow to shift from the index reproduction mode to the main image reproduction in the digital camera 1. The flow will be described with reference to FIG. 16. First, the operator operates the operating section 24 of the digital camera 1 to select the index reproduction mode and start an index reproduction operation (S157). Moreover, the image data as an object to be reproduced as the main image is selected from the plurality of thumbnail images in an index reproduction screen (S158). When the operating section 24 is operated to shift to the main image reproduction, the system controller 26 detects this operation, and displays the selected thumbnail image as the main image in the whole screen of the LCD 23 as shown in FIG. 15B in the main image reproduction mode of the LCD 23 (S159)

Subsequently, there is read out into the RAM 18 the number of the times to shift from thumbnail to main image stored in the storage region of the number of the times to shift from thumbnail to main image in a management data region such as the header or the footer of the image data selected and displayed as the main image (S160), and one is added to the number of the times to shift from thumbnail to main image read out into the RAM (S161). The number of the times to shift from thumbnail to main image, to which one has been added, is overwritten and stored again in the storage region of the number of the times to shift from thumbnail to main image in a management data region such as the header or the footer of the image data (S162), thereby ending the flow.

Next, the flow will be described with reference to FIG. 17. The operator operates the operating section 24 of the digital camera 1 to start photographing (S163), and accesses the recording medium 17 of the digital camera 1 to check a remaining amount of the recording medium 17 (S164). When the remaining amount of the recording medium 17 is large than one photographable picture (predetermined amount) of the photographing mode at that time, the operation shifts to the photographing operation (S169). The photographing is performed to record the photographed image data in the recording medium 17 (S170). When the photographing is not to be continued, the photographing is ended. To continue the photographing, the flow returns to S164 (S171).

When it is judged in S164 that the remaining amount of the recording medium 17 is smaller than the predetermined amount, the number of the times to shift from thumbnail to main image, stored in the storage region of the number of the times to shift from thumbnail to main image in a management data region such as the header or the footer of all the image data, is read into the RAM 18 (S165). It is judged whether or not the number of the times to shift from thumbnail to main image of all the image data is zero (S166). If the number of the times to shift from thumbnail to main image is all zero, a degree of importance of the image data as an erasing object cannot be compared or judged. Since the remaining amount of the recording medium 17 is running short, it is indicated to the operator that the photographing cannot be performed, thereby ending the flow.

If the number of the times to shift from thumbnail to main image of all the image data is not zero, the image data having the smallest number of the times to shift from thumbnail to main image is automatically selected (S167), the selected image data is erased (S168), and the operation returns to S164, and after S164 is repeated. However, in the repeated operation, in S167 the data having the second smallest number of the times to shift from thumbnail to main image is selected and erased, and the data having the small number of the times to shift from thumbnail to main image is selected and erased in order until the remaining amount of the recording medium 17 becomes larger than one photographable picture (predetermined amount) in the photographing mode.

At this time, in a case where there exist a plurality of, for example, two image data having the largest number of the times to shift from thumbnail to main image, all the plurality of data may be selected and erased. In this case, since a recording capacity corresponding to a capacity of the plurality of erased data is produced, the photographing of not only one picture but also the plurality of pictures might newly be performed. Alternatively, the image data having the old date may preferentially be selected from the plurality of image data, and the only old image data may be erased.

It is to be noted that as a case where the degree of importance of the image data as the erasing object cannot be compared or judged, there has been described a case where the number of the times to shift from thumbnail to main image is zero. For example, even in a case where all the image data have the equal number of the times to shift from thumbnail to main image, processing may be performed in the same manner as described above. Alternatively, in the case where all the image data have the equal number of the times to shift from thumbnail to main image, the data having the old date may preferentially be selected in the same manner as in the case where there exist a plurality of, for example, two image data having the largest number of the times to shift from thumbnail to main image.

Thus, in Example 4, when the remaining amount of the recording medium 17 comes short, the image data having the smallest number of the times to shift from thumbnail to main image is automatically selected and erased to thereby produce the recording region. Since the image data as an erase processing object is selected regardless of whether or not the image data is new, it is possible to secure a necessary recording region without requiring an operator's trouble, and the recording of the image data can smoothly be continued.

### EXAMPLE 5

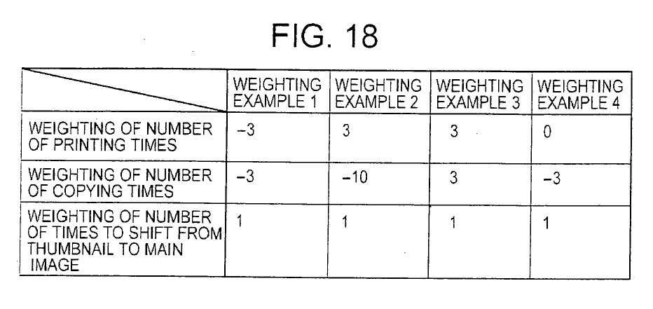

In Example 5, the number of copying times, the number of printing times, and the number of times to shift from thumbnail to main image is weighted, and data to be erased is automatically selected in accordance with weighting. That is, the numbers of the printing times acquired in Examples 1, 3, the number of the copying times acquired in Example 2, and the number of the times to shift from thumbnail to main image acquired in Example 4 are weighted, respectively. The data to be erased is automatically selected in accordance with a weighting result. Example 5 will be described with reference to mainly FIGS. 18 to 20.

In the same manner as in the above examples, an operator starts a photographing operation, and accesses a recording medium 17 of a digital camera 1 to check a remaining amount of the recording medium. When the checked remaining amount of the recording medium 17 is larger than one photographable picture in a photographing mode during the checking, the operation shifts to the photographing operation. When the checked remaining amount of the recording medium is small, management data regions such as headers or footers of all image data recorded in the recording medium are accessed, and the numbers of the printing times acquired in Examples 1, 3, the number of the copying times acquired in Example 2, and the number of the times to shift from thumbnail to main image acquired in Example 4 are read out into an RAM 18, respectively. That is, the digital camera 1 of Example 5 has all of copying times information, printing times information, and information of the number of the times to shift from thumbnail to main image.

The readout numbers of the printing times, the number of the copying times, and the number of the times to shift from thumbnail to main image are weighted, respectively. FIG. 18 shows four examples of weighting. In Weighting Example 1, since the image data is printed or copied into another recording medium, a large number of prints or copies based on the image data have already existed. Therefore, it is considered that original image data of the prints or the copies may be erased, and a weighting level of the number of the copying times and the number of the printing times is set to minus three-folds. On the other hand, as to the number of the times to shift from thumbnail to main image, if a main image is frequently browsed, the number of times when the operator has an interest in the image is large. Therefore, it is considered the number is important image data, and must not be erased. Therefore, the weighting level is set to one-fold. When the copy is a digital copy, the same image data as that of an original image is present. Therefore, even if the original image is erased, there is not any disadvantage. It is to be noted that in any of Weighting Examples 2 to 4 described later, the weighting level of the number of the times to shift from thumbnail to main image is set to one-fold.

In Weighting Example 2, it is considered that in a case where data has been copied to another recording medium, if original image data is erased, there is not any problem, and a weighting level of the number of copying times is set to minus ten-folds. On the other hand, it is considered that when the number of printing times is large, the image data is important, the weighting level of the number of the printing times is set to three-folds. The weighting level of the number of times to shift from thumbnail to main image is set to one-fold as described above. That is, a degree of importance of information of the number of the times to shift from thumbnail to main image is set to be greater than that of information of the number of the printing times.

In Weighting Example 3, it is considered that when the number of printing times and the number of copying times are large, images are important, respectively, and weighting levels of the number of the copying times and the number of the printing times are both set to three-folds. The weighting level of the number of times to shift from thumbnail to main image is one-fold as described above.

In Weighting Example 4, it is considered that even if the number of printing times is large, erasing or resizing of original image data itself is to be avoided, the weighting level of the number of the printing times is set to zero-fold, and ignored. It is considered that if the data is already copied, the data may be erased, and the weighting level of the number of copying times is set to minus three-folds. The weighting level of the number of times to shift from thumbnail to main image is one-fold as described above. That is, in Weighting Example 4, only information of the number of the copying times and the number of the times to shift from thumbnail to main image are utilized as a measure to judge a degree of importance of the image data. The number of the printing times is not employed as the measure of the degree of importance.

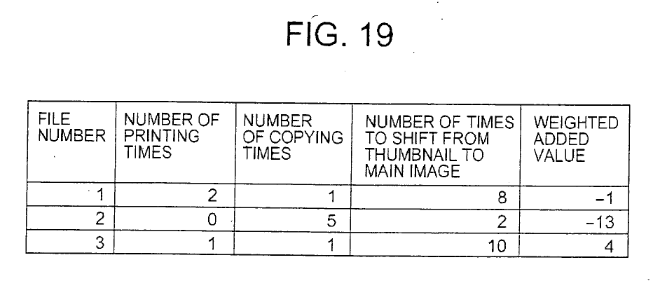

Weighted times information are added up such as printing times information, copying times information and information of the number of times to shift from thumbnail to main image obtained by weighting the information of the number of the printing times, the number of the copying times and the number of the times to shift from thumbnail to main image recorded in the management data region, respectively, to obtain numerical information for judging the degree of importance of the image. The image data having the smallest numeric value of an addition result is automatically selected, and the selected image data is erased. FIG. 19 shows examples of added values in a case where Weighting Example 1 is employed. As shown in FIG. 19, it is assumed that the number of the printing times of the image data having a file number 1 is 2, the number of the copying times is 1, the number of the times to shift from thumbnail to main image is 8, the number of the printing times of the image data having a file number 2 is 0, the number of the copying times is 5, the number of the times to shift from thumbnail to main image is 2, the number of the printing times of the image data having a file number 3 is 1, the number of the copying times is 1, and the number of the times to shift from thumbnail to main image is 10. In Weighting Examples 1 to 4, an operating section 24 of the digital camera is operated and selected (switched), and the operating section 24 functions as weighting switch means. It is to be noted that Weighting Examples 1 to 4 are simply examples, and a combination of weighting details, the weighting level, and the number of types of weighting can arbitrarily be selected and set. The operating section 24 of the digital camera may be used to change the combination or the weighting level.

According to Weighting Example 1 of FIG. 18, the weighted addition result of the image data having the file number 1 is −1 (=−6−3+8), the result of the image data having the file number 2 is −13 (=0−15+2), and the result of the image data having the file number 3 is 4 (=−3−3+10). Among the three image data, the image data having the smallest added value and having the file number 2 is judged to have the smallest degree of importance, automatically selected and erased.

When the erasing is completed, the remaining amount of the recording medium is checked again. When the checked remaining amount of the recording medium is larger than one photographable picture, the operation shifts to the photographing operation. When the checked remaining amount of the recording medium is small, the erasing operation is repeated. Needless to say, during the repeating, the data is erased in order from the data having the small added value as described above.

At this time, in a case where there exist a plurality of, for example, two image data having the smallest added value, all the plurality of data may be selected and erased. In this case, since a recording capacity corresponding to a capacity of the plurality of erased data is produced, the photographing of not only one picture but also the plurality of pictures might newly be performed. Alternatively, the image data having the old date is preferentially selected from the plurality of image data, and the only old image data may be erased. Alternatively, the plurality of image data having the equal added value may be compared with one another by specific times information such as the printing times information, and the data having the small number of the printing times may be selected.

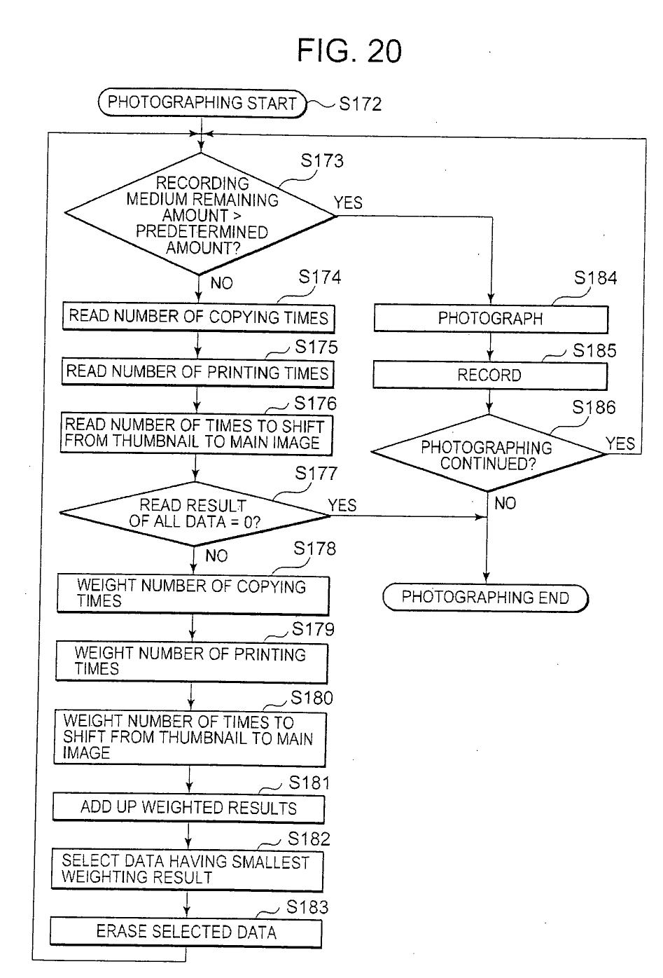

FIG. 20 shows a flow chart to automatically select data to be erased in accordance with the result of the weighting. An operator operates the operating section 24 of the digital camera 1 to start the photographing (S172), and the recording medium 17 of the digital camera 1 is accessed to check the remaining amount of the recording medium (S173). In a case where the remaining amount of the recording medium is larger than one photographable picture (predetermined value) in the photographing mode at that time, the operation shifts to the photographing operation (S184). The photographing is performed to record the photographed image data in the recording medium 17 (S185). When the photographing is not to be continued, the photographing is ended. To continue the photographing, the flow returns to S173 (S186).

When the remaining amount of the recording medium 17 is smaller than the predetermined amount, the number of the copying times, the number of the printing times and the number of the times to shift from thumbnail to main image are read into the PAM 18, respectively. That is, the copying times information stored in a storage region of the number of the copying times in a management data region such as the header or the footer of the image data recorded in the recording medium 17 is read into the RAM 18 (S174), the printing times information stored in a storage region of the number of the printing times in the recording medium is read into the RAM 18 (S175), and the information of the number of the times to shift from thumbnail to main image stored in a storage region of the number of the times to shift from thumbnail to main image in the recording medium is read into the RAM 18 (S176).

It is judged whether or not the number of the copying times, the number of the printing times and the number of the times to shift from thumbnail to main image of all the read data are all zero, the degree of importance of the image data as an erasing object cannot be compared or judged. Therefore, it is indicated with respect to the operator that the remaining amount of the recording medium is running short and that the photographing cannot be performed, thereby ending the flow. If the number is not zero, the number of the copying times, the number of the printing times and the number of the times to shift from thumbnail to main image read into the RAM 18 are weighted, respectively, and stored again in the RAM. That is, the number ol the copying times read into the RAM 18 in S174 is weighted and stored in the RAM (S178), the number of the printing times read into the RAM in S175 is weighted and stored in the RAM (S179), and the number of the times to shift from thumbnail to main image read into the RAM in S176 is weighted and stored in the RAM (S180). It is to be noted that in addition to contents described in Weighting Examples 1 to 4, the weighted value may arbitrarily be set. It is assumed that the contents of the weighting are set beforehand by the operation of the operating section 24 of the digital camera. It is assumed that selecting and switching from a plurality of types of weighting and setting of new weighting contents may be performed at arbitrary timings.

The numeric vales of the copying times information, the printing times information and the information of the number of the times to shift from thumbnail to main image weighted in S178, S179 and S180 are added up and stored in the RAM 18 (S181), and the image data having the smallest added value (weighted added value) is selected (S182). The selected image data is erased (S183), and the flow returns to S173. When the remaining amount of the recording medium 17 is larger than the predetermined amount, the operation shifts to the photographing operation (S184).

Thus, in Example 5, when the remaining amount of the recording medium 17 is running short, the number of the printing times, the number of the copying times and the number of the times to shift from thumbnail to main image are weighted and added up, and the image data having the smallest added value is automatically selected and erased to thereby produce s recording region. Moreover, since the image data as an erase processing object is selected regardless of whether or not the image data is new, a necessary recording region can be secured without requiring any operator's trouble, and the image data can smoothly be continued to be recorded. Since three types of times information such as the number of the printing times, the number of the copying times and the number of the times to shift from thumbnail to main image are considered, the image data as a processing object can exactly be selected.

When at least two of three types of times information such as the number of the printing times, the number of the copying times and the number of the times to shift from thumbnail to main image are considered, the image data as the processing object can exactly be selected as compared with a case where one type of times information is utilized. Furthermore, when all of three types of times information are considered, the image data as the processing object can most exactly be selected.

As shown in FIG. 18, in a constitution in which a plurality of combinations of different types of weighting are defined (four examples in the figure), and the combination is switched utilizing weighting switch means such as the operating section 24 of the digital camera 1, the image data as the erasing object can be selected in accordance with various combinations of the weighting operations. Therefore, a breadth of selection enlarges, and it is possible to cope with operator's various choices.

### EXAMPLE 6

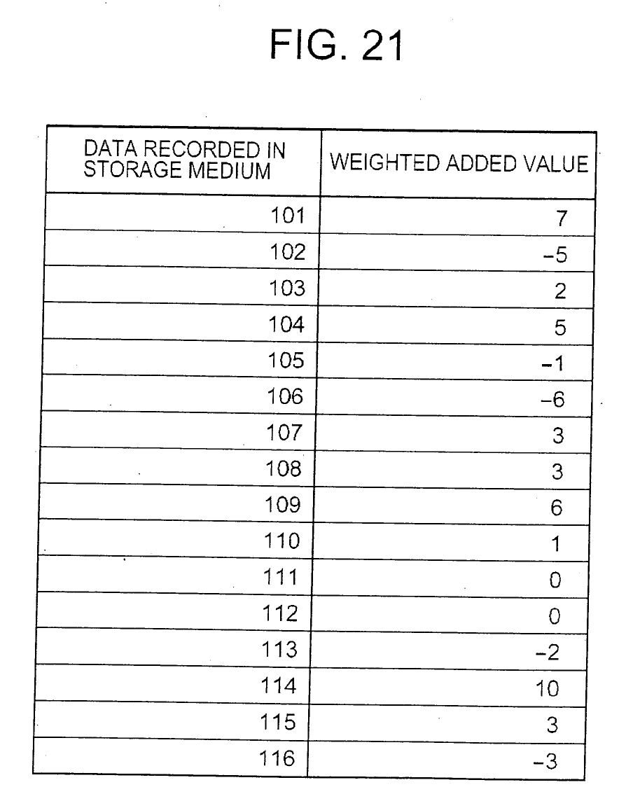

In Example 6, the number of copying times, the number of printing times and the number of times to shift from thumbnail to main image are weighted and added up, and image data is compressed, resized or erased in accordance with the resulting added value (weighted added value) to secure a necessary remaining amount. Example 6 will be described with reference to mainly FIGS. 21 to 23.

First, as described in Example 5, the number of the printing times, the number of the copying times and the number of the times to shift from thumbnail to main image are weighted and added up to calculate the added value for each image data. In a memory secure mode 1, the image data are compressed in order from the image data having the smallest added value (weighted added value). In a memory secure mode 2, the image data are resized in order from the image data having the smallest added value. In a memory secure mode 3, the image data are erased in order from the image data having the smallest added value. Thus, the performing of the compressing, resizing or erasing is set beforehand every memory secure mode, the compressing is performed in the memory secure mode 1, the resizing is performed in the memory secure mode 2, and the erasing is performed in the memory secure mode 3. It is to be noted that, needless to say, during the resizing, the image data having a pixel size reduced is replaced with original image data, and during the compressing, the image data compressed at a compression ratio larger than the existing compression ratio is replaced with the original image data.

Furthermore, the number of the data to be compressed, resized or erased in the memory secure mode 1, 2 or 3 is set as a memory secure level. For example, in a memory secure level 1, four data are compressed, resized or erased in the memory secure mode 1, 2 or 3. In a memory secure level 2, eight data are compressed, resized or erased in the memory secure mode 1, 2 or 3. In a memory secure level 3, 12 data are compressed, resized or erased in the memory secure mode 1, 2 or 3.

A constitution is useful in which in a case where a remaining recording capacity of a recording medium 17 of a digital camera 1 is small, warning or the like is displayed to an operator to prompt the operator to prepare a replacing recording medium or secure a recording capacity by erasing an unnecessary image. When the number of remaining photographable pictures is, for example, five or less, the warning is displayed. When the remaining recording capacity of the recording medium is four image data in a photographing mode at that time, the operator is notified by the display of the warning or the like that the number of the remaining photographable pictures is five or less and the recording capacity is small. The operator presses a memory remaining amount secure button of an operating section 24 of the digital camera 1. When a system controller 26 of the digital camera 1 detects this operation, the operator is prompted to select the memory secure mode 1, 2 or 3 and the memory secure level 1, 2 or 3. When the operator selects the memory secure mode and the memory secure level, respectively, the data are compressed, resized or erased to increase the remaining amount of the recording medium. Even in a case where the remaining amount of the recording medium is smaller than an amount for one image data in the photographing mode set at the time, the data are compressed, resized or erased by a similar method to increase the remaining amount of the recording medium. Thus, the operating section 24 of the digital camera 1 is operated to thereby set the compressing, resizing or erasing to be performed, and the operating section functions as processing set means. In the preparation operation, after the processing contents are selected beforehand, the memory remaining amount secure button may be pressed to instantly start the resizing, compressing or erasing of the image data. Even in a case where the number of the data is set in accordance with the memory secure level, the processing contents may similarly be selected beforehand. Furthermore, even the number of the data that can be set in accordance with the memory secure level may be set to the arbitrary number except 4, 8 and 12 described above by the operating section 24 of the digital camera.

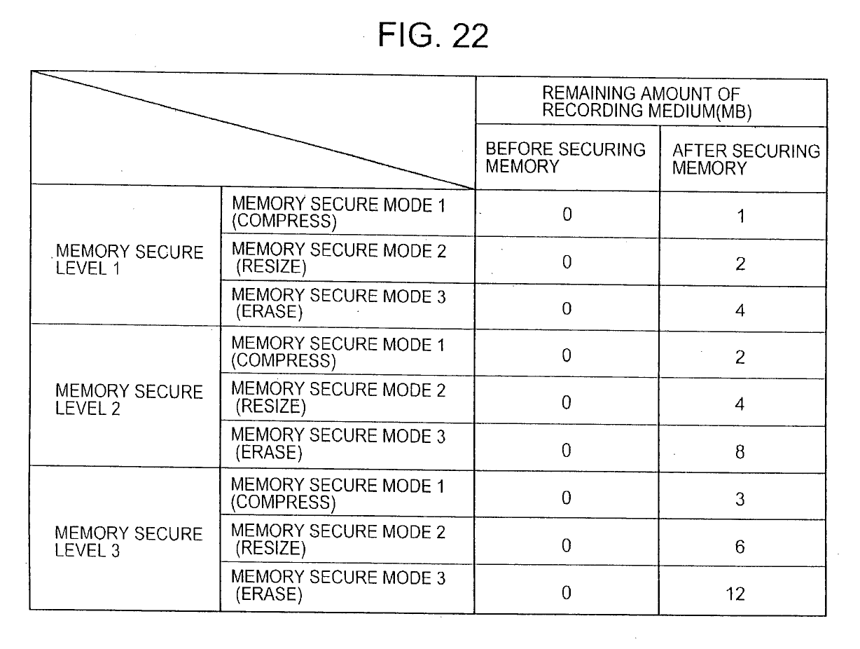

FIG. 21 shows added values (weighted added values) of the respective image data obtained by calculation described in Example 5 (stored in the recording medium 17). FIG. 22 shows remaining amounts of the recording medium before and after execution of a memory secure operation in a case where the memory secure mode is combined with the memory secure level. For example, it is supposed that in the 16 MB recording medium 17, 16 image data are stored including data 101 to 116 each having an image size 1 MB.

As seen from FIG. 22, since the remaining amount of the recording medium before the memory secure operation is 0 MB in any of the memory secure modes 1, 2 and 3 of the memory secure level 1, 2 or 3, the warning indicating that the remaining amount of the recording medium is small is displayed to prompt the operator to increase the recording medium remaining amount. For example, when the operator selects “the number of the data: 4” in the memory secure level 1, and “the resizing of the data in order from the data having the small value” in the memory secure mode 2, four data (data 106 (−6), 102 (−5), 116 (−3) and 113 (−2)) are selected from the data 101 to 116 in order from the data having the smallest weighted added value, and the selected data is resized into ½. As a result of the resizing into ½, the remaining amount of the recording medium 17 is 2 MB (1 MB×4×½=2 MB). Assuming that the data amount of the photographed image is 1 MB per image, two pictures can be photographed.

It is to be noted that in Example 6, the detailed contents of the memory secure level are three types, but the memory secure level is not limited to three types. For example, a memory secure level 4 may be added to select 16 image data. Needless to say, it is possible to arbitrarily a compression ratio and a resize ratio of the memory secure mode, and the number of the image data as objects of the memory secure level.

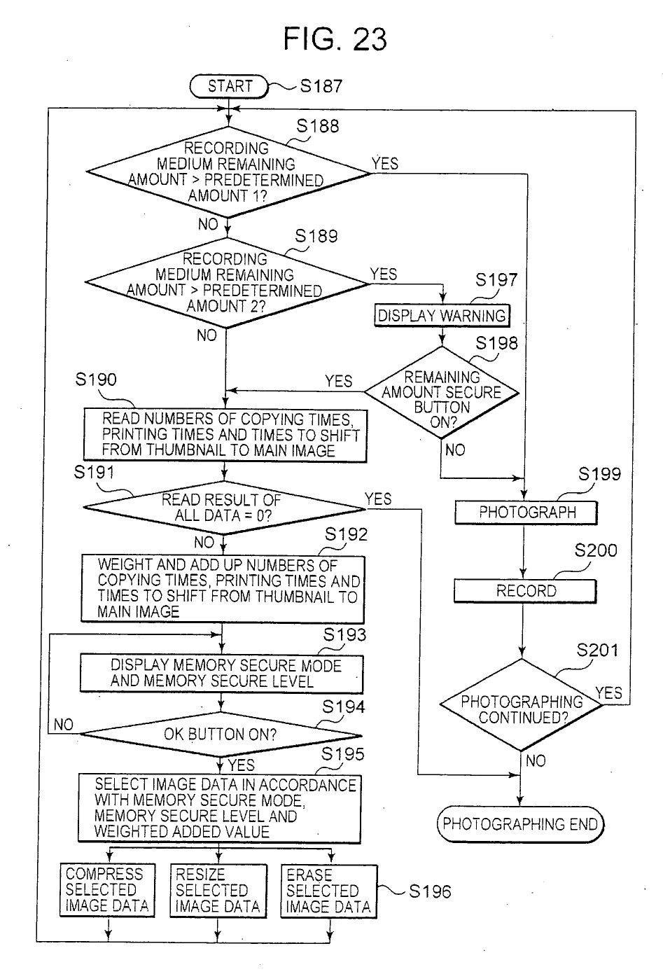

FIG. 23 shows a flow chart in a case where the number of the copying times, the number of the printing times and the number of the times to shift from thumbnail to main image are weighted and added up, and the data is compressed, resized or erased in accordance with the added value (weighted added value).

The operator operates the operating section 24 of the digital camera 1 to start the photographing (S187), and the recording medium 17 of the digital camera 1 is accessed to check the remaining amount of the recording medium 17 (S188). In a case where the remaining amount of the recording medium 17 is the predetermined number of photographable pictures, for example, five pictures or more in the photographing mode, the operation shifts to the photographing operation (S199). The photographing operation is performed to record the image data in the recording medium (S200). The boerator determines whether or not to continue the photographing (S201). When the photographing is not to be continued, the photographing is ended. To continue the photographing, the flow returns to S188, and the photographing is repeated until the remaining amount of the recording medium 17 becomes less than five photographable pictures in the photographing mode.

When the remaining amount of the recording medium 17 is less than five photographable pictures in the photographing mode, the remaining amount is checked again in S189. When the remaining amount of the recording medium is one photographable picture or more in the photographing mode, a warning is displayed in an LCD 23, which indicates that the number of the photographable pictures is less than five, and the remaining amount is small, to notify the operator. The operator is prompted to perform the memory secure operation (S197). It is judged whether or not the memory remaining amount secure button has been pressed (S198). When it is detected that the memory remaining amount secure button has been pressed, the flow advances to S190. When it is not detected, the flow advances to S199.

In S190, the number of the printing times, the number of the copying times and the number of the times to shift from thumbnail to main image in a management data region such as a header or a footer of the image data recorded in the recording medium 17 are read into an RAM 18. Moreover, it is judged whether or not the read number of the printing times, the number of the copying times and the number of the times to shift from thumbnail to main image of all the image data are all zero (S191). If the numbers are zero, a degree of importance of the image data as a resizing, compressing or erasing object cannot be compared and judged. Therefore, it is indicated to the operator that since the remaining amount of the recording medium is running short, the photographing cannot be performed, thereby ending the flow. If the numbers are not zero, the number of the printing times, the number of the copying times and the number of the times to shift from thumbnail to main image of each image data are weighted and added up (S192).

The memory secure mode and the memory secure level are displayed in the LCD 23 to prompt the operator to select them (S193). It is judged whether or not the operator has selected the displayed memory secure mode and memory secure level and has pressed an OK button (S194). When the selection is ended, or the memory secure mode and the memory secure level prepared and indicated beforehand are accepted as they are, and the OK button is pressed, specific contents of the memory secure mode and the memory secure level are determined. During this operation, to change the displayed memory secure mode and memory secure level, a change button is pressed, it is detected that the change button has been pressed, the flow returns to S193, the next memory secure mode and memory secure level are displayed, and this operation is repeated until the operator's selection ends. It is to be noted that various buttons of the operating section 24 of the digital camera 1 are assigned as the memory remaining amount secure button, the OK button, the change button and the like.

In accordance with the memory secure mode and memory secure level selected and determined in S194 and the added value as the addition result of the respective image data weighted and added in S192, the image data set in accordance with the memory secure level are selected in order from the image data having the smallest added value (S195). The selected image data is compressed, resized or erased in accordance with the selected memory secure mode (S196), and the flow returns to S188.

It is assumed that a predetermined amount 1 (photographable pictures) is five pictures, and a predetermined amount 2 (photographable pictures) is one picture, when the remaining amount of the recording medium is checked in S188, S189. However, the predetermined value 1 of two pictures or more is sufficient, and it is not limited to five pictures.

Thus, in Example 6, in a case where the remaining amount of the recording medium 17 is running short, after any processing of the resizing, compressing and erasing to be performed is set, the image data as the object is automatically selected and subjected to the processing to produce a recording region. Moreover, since the image data as a resize, compress or erase processing object is selected regardless of whether or not the image data is new, it is possible to secure the necessary recording region without requiring any operator's trouble, and the recording of the image data can smoothly be continued. Since the operator's favorite processing can be set beforehand from three types of processing of the resizing, compressing and erasing, a breadth of selection enlarges, and it is possible to cope with operator's various choices.

Since the numbers of the data as the processing objects are set beforehand to “4”, “8” and “12” in the memory secure levels 1, 2 and 3, respectively, the secured number of the photographable pictures is predicted to a certain degree. Moreover, when the number of the photographable pictures to be secured is large, the memory secure level 3 may be set. When the number is small, the memory secure level 1 may be set. From this respect, the breadth of the selection enlarges, and it is possible to cope with operator's various choices.

When the number of the photographable pictures to be secured is input in S193, the number of the image data as the processing objects and the memory secure mode are automatically calculated and determined. Only one of the number of the image data and the memory secure mode, or a combination of them may be displayed to prompt the operator to perform selection. For example, in a case where ten image data are to be secured, there is a method in which the memory secure mode is determined beforehand to perform calculation, and the number of the image data to be resized, compressed or erased is indicated. Alternatively, a combination of the numbers of the object image data to be processed in each memory secure mode may be indicated. In this constitution, the number of the photographable pictures to be secured is securely obtained by one operation.

Moreover, after the number of the photographable pictures to be secured (the number of recordable pixel data) is calculated and determined, the number of the data as processing objects is obtained by calculation, and the processing is performed in accordance with the number of the data. Therefore, without repeating any processing, the necessary recording region can exactly be secured.

### EXAMPLE 7

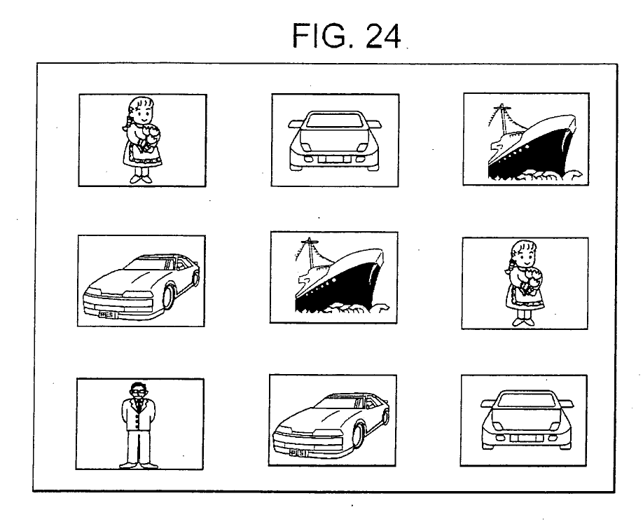

In Examples 1 to 6 described above, image data as a processing object is automatically selected and instantly processed. That is, in a case where a remaining amount of a recording medium is smaller than one photographable picture in a photographing mode (Examples 1 to 5), or the number of the photographable pictures becomes less than a predetermined amount (Example 6: five pictures), the image data is automatically selected and erased (Examples 1 to 5), or the data is compressed, resized or erased (Example 6). On the other hand, it is intended in Example 7 that a recording region is secured regardless of the remaining amount of the recording medium. The image data as resize, compress or erase processing objects are displayed as thumbnails before performing the resize, compress or erase processing, an operator confirms whether or not to execute the processing as it is, and the processing is executed. Example 7 will be described with reference to mainly FIGS. 24 to 26.

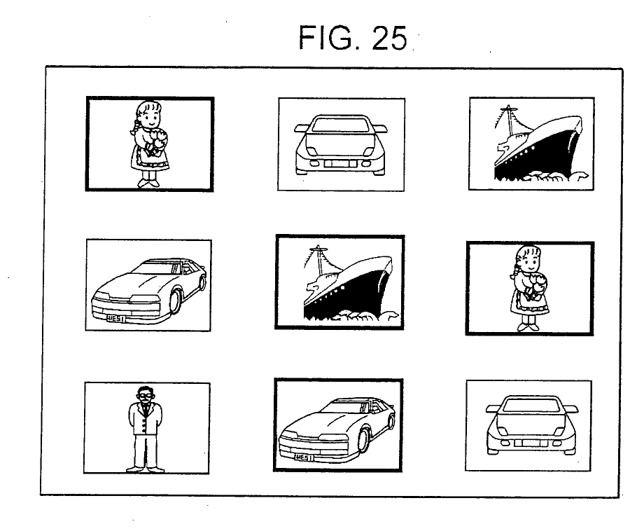

In a case where the operator intends to secure the recording region regardless of the remaining amount of a recording medium 17, the operator is prompted to select, for example, a memory secure mode and a memory secure level as described in Example 6. For example, when the operator selects a memory secure mode 3 and a memory secure level 3, processing objects, that is, the image data as erasing objects in this case are displayed as the thumbnails together. As shown in FIG. 24, thumbnail images of the image data as the erasing objects are displayed together. As shown in FIG. 25, frames of thumbnail images of image data automatically selected as erasing objects at the time are thickly emphasized, and erasing object images are indicated to the operator. FIG. 25 corresponds to a case where a memory secure level 1 is selected. Unlike a display mode of FIG. 24, FIG. 25 shows a mode to display even thumbnail images that are not erasing objects in a mixed manner, and shows a state in which four images are automatically selected as erasing objects from nine images displayed as the thumbnails.

In a case where all the image data as the erasing objects are erased, the operation shifts to an erasing operation as it is to erase all the image data as the erasing objects as they are. In a case where there is image data which the operator does not intend to erase among the image data as the erasing objects, the image data which is not to be erased is selected from the thumbnail images. An option is selected from three options: the selected image data is left as it is without being processed; the data is compressed; or the data is resized without being erased.

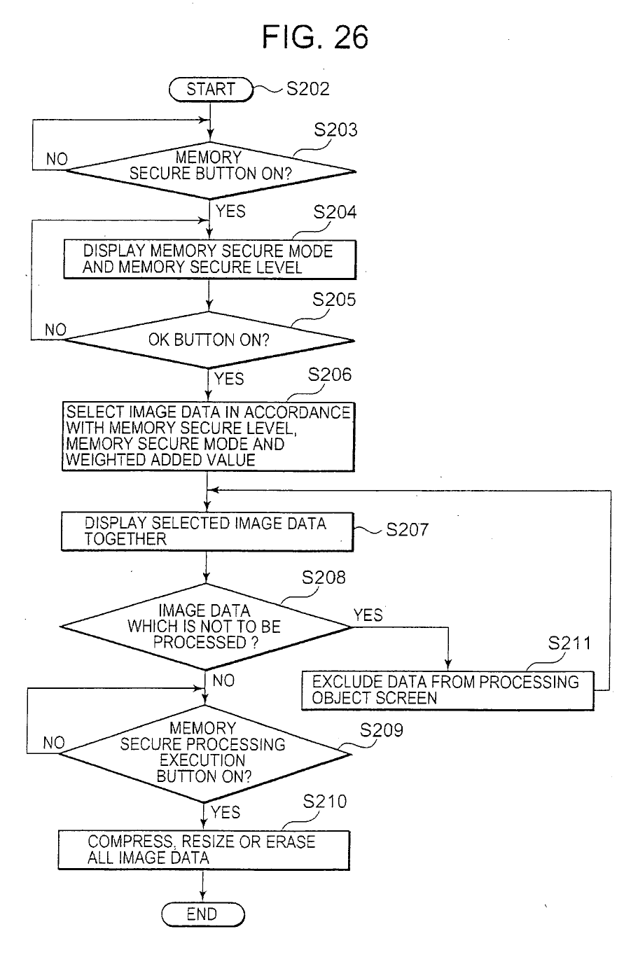

FIG. 26 shows a flow chart in a case where the image data is erased regardless of the remaining amount of the recording medium. When the operator intends to secure many recording regions (large memory remaining amount), a memory secure operation of a digital camera 1 is started (S202), and it is judged whether or not a memory secure button is pressed (S203).

When the memory secure button is not pressed, the flow returns to S203 until the button is pressed. When it is detected that the button has been pressed, the memory secure mode and the memory secure level are displayed in an LCD 23 (S204). It is judged whether or not the displayed memory secure mode and memory secure level are selected as they are (S205). When an OK button is pressed, and it is detected that the OK button is ON, the image data as a processing object is automatically selected in accordance with the memory secure mode and the memory secure level selected in S204 and a weighted addition result value described in Example 5 (S206). When the OK button is not pressed, an operating section 24 of the digital camera 1 is operated to change the memory secure mode and the memory secure level, the flow returns to S204, the changed memory secure mode and memory secure level are displayed, and this operation is repeated until it is detected that the OK button has been turned on.

When the thumbnail images of the image data automatically selected in accordance with an ON-state of the OK button are displayed together in the LCD 23 (S207). Before subjecting all of the data displayed together to the processing in the memory secure mode (any of the compressing, resizing and erasing) determined in S205, the operator judges whether or not each image data may be subjected to the processing defined in the memory secure mode as it is. When it is judged that the defined processing is not to be performed, the operator further judges the compress, resize or erase processing to be performed (S208). When a system controller 26 detects, with respect to all the data, an execution command of memory secure processing to start the compress, resize or erase processing defined in the memory secure mode, the image data automatically selected in S206 is compressed, K resized or erased in accordance with the memory secure mode selected and determined in S205 (S210), thereby ending the flow.

In a case where it is judged in S208 that there exists the image data which is not to be subjected to the processing defined in the memory secure mode, the operating section 24 is operated so as to select the image data from the displayed thumbnail images and exclude the data from processing object images. When the image data is excluded, the corresponding image data is deleted from a thumbnail display screen, and is not displayed. The flow returns to S207, and the processing object image is displayed as the thumbnail again. It is to be noted that in the display mode shown in FIG. 25, when the images are excluded from the processing object images, frames of the excluded thumbnail images are not thickly emphasized.

Even in Example 7, as described in Example 5, the number of image printing times, the number of copying times and the number of times to shift from thumbnail to main image are weighted and added up, and the image data having the smallest added value is automatically selected and compressed, resized or erased. Moreover, since the image data as an erase processing object is selected regardless of whether or not the image data is new, a necessary recording region can be secured without requiring any operator's trouble, and the image data can smoothly be continued to be recorded. Since the image data as the processing object can be selected during the weighting, a breadth of selection enlarges, and it is possible to cope with operator's various choices. When at least two types of times information among the number of the printing times, the number of the copying times and the number of the times to shift from thumbnail to main image are considered, the image data as the processing object can exactly be selected as compared with a case where only one type of times information is considered.

When as shown in FIG. 18, a plurality of (four examples in the figure) combinations of different types of weighting are defined, and the combinations are switched utilizing weighting switch means such as the operating section 24 of the digital camera, the image data as the erasing object can be selected by the combination of various types of weighting. Therefore, a breadth of selection enlarges, and it is possible to cope with operator's various choices. Even when the weighting level of at least one piece of times information is set to zero as in Weighting Example 4 of FIG. 18, the breadth of selection enlarges, and it is possible to cope with the operator's various choices.

In Example 7, the image data automatically selected as the processing objects are displayed as the thumbnails before the processing is executed. After the operator confirms the data, the data is processed. Therefore, the processing object image can be confirmed beforehand, and erroneous processing of the necessary image data is prevented. Especially, when the frame of the thumbnail image is indicated in such an emphasized manner as to be identified, the processing object image can easily be recognized. Needless to say, an constitution of an image data processing device is not complicated, and the device can be comparatively miniaturized and lightened.

Moreover, when the memory secure mode is changed or the necessary image data is excluded from the processing objects to further execute the processing other than the erasing, the image data is subjected to different processing. The breadth of selection enlarges, and it is possible to cope with the operator's various choices.

### EXAMPLE 8

In Example 8, instead of automatically processing image data as a processing object selected in accordance with the number of printing times, the number of copying times, and the number of times to shift from thumbnail to main image, an operator is requested to judge whether or not to perform the processing. Example 8 will be described with reference to mainly FIGS. 24 and 25, and 27 and 28.

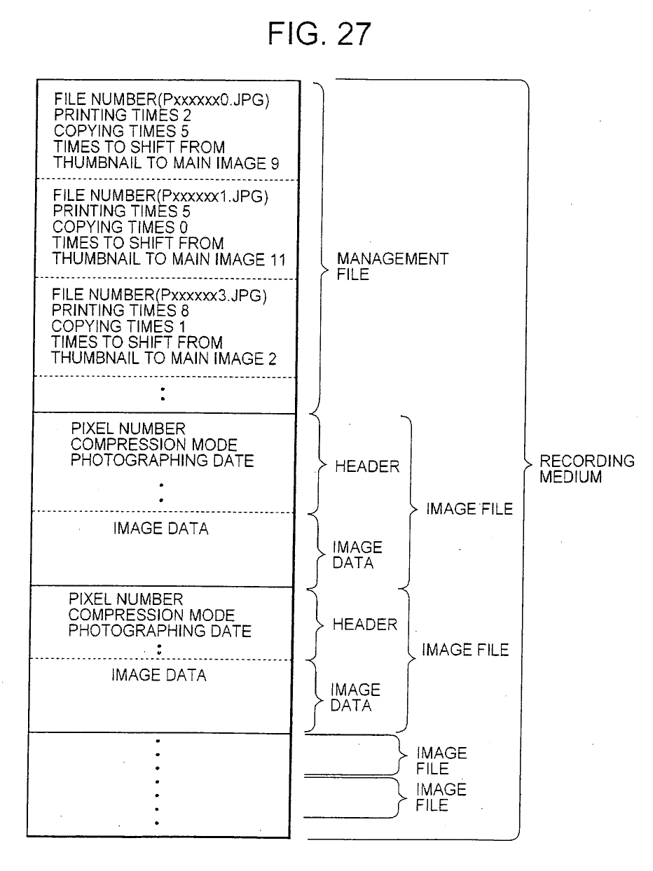

In Examples 1 to 7, the number of the printing times, the number of the copying times and the number of the times to shift from thumbnail to main image are stored in a management data region such as a header or a footer of the image data as shown in FIG. 4. On the other hand, in Example 8, the number of the printing times, the number of the copying times and the number of the times to shift from thumbnail to main image are stored in a management file (image importance degree management file) for exclusive use. FIG. 27 shows the management data region of a recording medium 17. In this management file (image importance degree management file), there are stored identification information such as a file number of each image data, printing times information of the image data, copying times information and information of the number of the times to shift from thumbnail to main image.

Thus, when image data information such as the number of the printing times, the number of the copying times and the number of the times to shift from thumbnail to main image of each image data are stored in parallel with an image file as separate information independent of the image file forming the image data, an amount of the data recorded in the image file itself is reduced. The image data information such as the number of the printing times, the number of the copying times and the number of the times to shift from thumbnail to main image concerned with a plurality of image data are recorded integrally as one piece of image information. A plurality of pieces of image data information are stored in one file. Therefore, history information such as the number of the printing times, the number of the copying times and the number of the times to shift from thumbnail to main image of all the image data can quickly be searched and grasped as compared with a case where the image files are individually accessed to grasp the information. The image data as the processing object is selected in a short time.

In Examples 1 to 6, the image data as an erasing object is selected, and automatically erased or processed otherwise. On the other hand, in Example 8, instead of automatically erasing, for example, the image data as the erasing object determined in accordance with the number of the copying times, the number of the printing times and the number of the times to shift from thumbnail to main image, the operator is requested to judge whether or not to erase the data. At this time, as shown in FIG. 24, thumbnail images of the image data as the erasing objects are displayed together in an LCD 23. Alternatively, as shown in FIG. 25, the thumbnail images of the image data recorded in the recording medium are displayed together, and frames of the thumbnail images of the image data as the erasing objects are emphasized. The object images of the erasing are indicated to the operator in this manner.

When the operator judges that the automatically selected image data may be erased, the data is erased. When it is judged that the data is not to be erased, the next erasing object data is selected and indicated. Moreover, this operation is repeated.

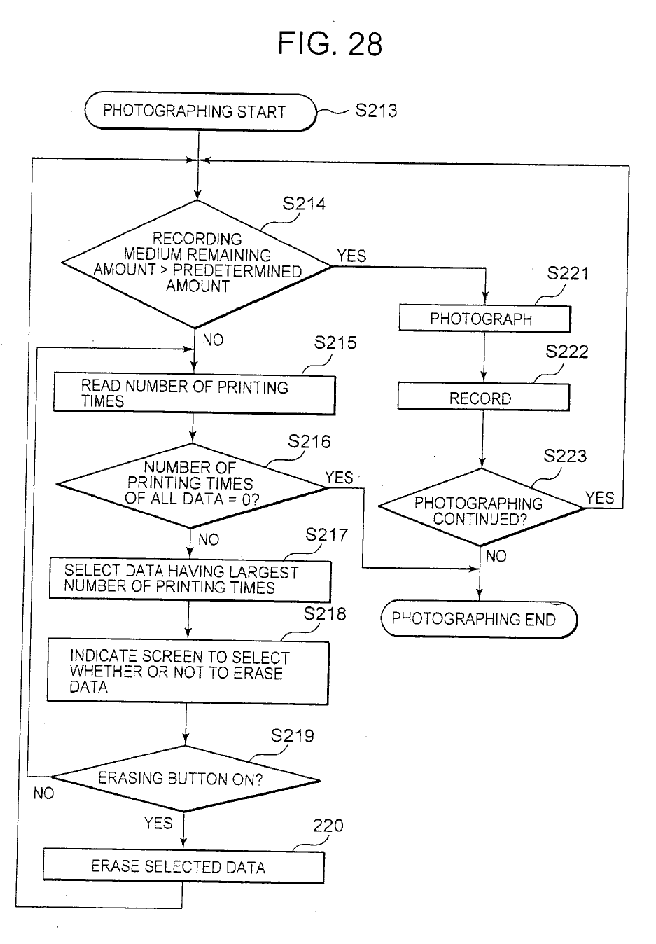

FIG. 28 shows a flow chart in which the operator is requested to judge whether or not to erase the erasing object data in a case where the image data selected in Example 2 and having the largest number of the printing times is erased.

In FIG. 28, S213 to 217 and S221 to 223 correspond to S107 to 111 and S113 to 115 of FIG. 6 of Example 2. The operator operates an operating section 24 of a digital camera 1 to start photographing (S213), and the recording medium 17 of the digital camera 1 is accessed to check a remaining amount of the recording medium (S214). When the remaining amount of the recording medium 17 is larger than one photographable picture (predetermined amount) in a photographing mode at the time, the operation shifts to a photographing operation (S221), and the photographing operation is performed to record the image data in the recording medium (S222). When the photographing is not to be continued, the photographing is ended (S223). To continue the photographing, the flow returns to S214.

When the checked remaining amount of the recording medium 17 is smaller than the predetermined amount, the printing times information of all the image data recorded in the image importance degree management file of the recording medium 17 is read into an RAM 18 (S215). It is judged whether or not the number of the printing times of all the data is zero (S216). If the number is zero, a degree of importance of the image data as the erasing object cannot be compared and judged, and the remaining amount of the recording medium 17 is running short. Therefore, it is indicated to the operator that the photographing cannot be performed, thereby ending the flow. If the number is not zero, the image data having the largest number of the printing times is selected (S217).

The selected image data is displayed in the LCD 23 of the digital camera 1 (S218), and it is judged whether or not to erase the displayed image data (S219). When the operator judges that the data is to be erased, and a system controller 26 detects that an erasing button has been turned on, the selected image data is erased (S220), and the flow returns to S214 to repeat the erasing operation. When the operator judges in S219 that the data is not to be erased, and the erasing button is not pressed for a predetermined time, the flow returns to S215 to again read the number of the printing times of image data other than the image data judged not to be erased by the operator, and the image data having the second largest number of the printing times is selected.

The erasing of the image data having the largest number of the printing times has been illustrated, but the erasing object is not limited to this example. That is, in Example 8, the object judged to be erased or not may be image data selected in accordance with the number of the copying times into another recording medium or the number of the times to shift from thumbnail to main image, weighted values obtained by weighting the numbers, or weighted added values obtained by weighting and adding up the numbers.

It is to be noted that the image data as the object is erased to secure a storage region, but this is not limited to the erasing, and needless to say, the storage region may be secured by resizing or compressing.

In Example 8, the image data as the processing object is automatically selected, and displayed before processed. After the operator confirms the display, the data is processed. Therefore, the image data as the processing object can be confirmed in advance. Therefore, regardless of the number of the printing times, the number of the copying times and the number of the times to shift from thumbnail to main image, erroneous processing of the image data which is not to be processed by the operator can be prevented. Therefore, each image data is appropriately processed, a breadth of selection enlarges, and it is possible to cope with operator's various choices. It is to be noted that the object image data may be displayed one by one, or the thumbnail images may be displayed.

### EXAMPLE 9

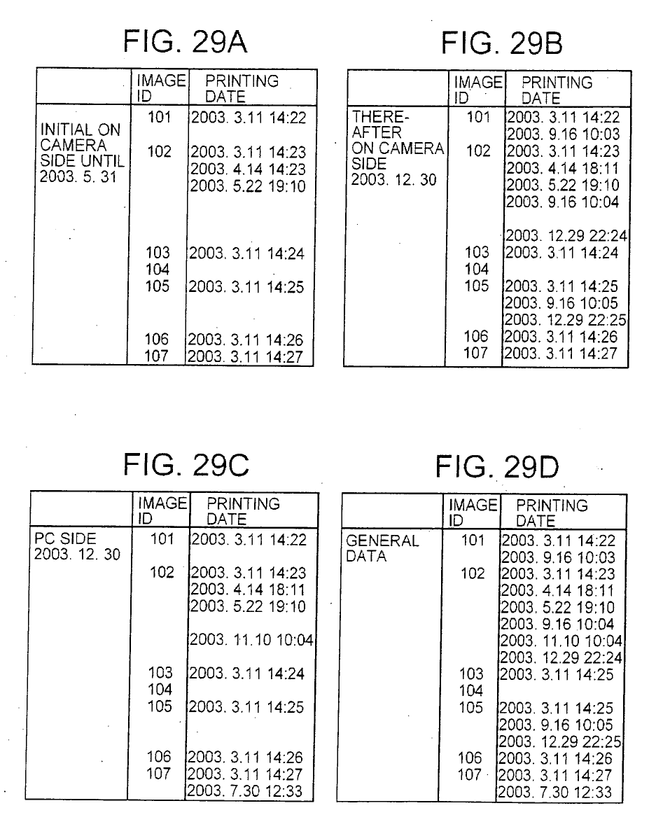

In Example 3, a digital camera is connected to a personal computer to transmit identification information such as a serial number of the digital camera to the personal computer. A case where there are transmitted not only identification information such as the serial number of the camera but also history information such as printing times information, copying times information, information of the number of times to shift from thumbnail to main image and execution date information will be described as Example 9 with reference to FIG. 29.

For example, a digital camera 1 is connected to a personal computer 3 by a USB cable or the like, and image data recorded in the digital camera 1 is copied into the personal computer 3. Thereafter, the USB cable is detached to disconnect the digital camera 1 from the personal computer 3. In the disconnected state, printing by use of image data recorded in the digital camera 1 is performed independently of printing by use of image data copied into the personal computer 3. Therefore, even if the same image data is printed from the image data recorded in the digital camera 1 four times, and printed from the image data copied into the personal computer 3 five times, the digital camera 1 cannot grasp printing history in the personal computer 3, and the personal computer 3 cannot grasp printing history in the digital camera 1. In Example 9, even in such a case, the total number of printing times performed independently in the digital camera 1 and the personal computer 3, respectively, is grasped. Finally, nine printing times in total are grasped as the history of the number of the printing times in the digital camera 1.

In Example 9, the digital camera 1 is connected to the personal computer 3, and the image data is copied from the digital camera 1 into the personal computer 3. In addition, in an image importance degree management file stored in a hard disk 41 of the personal computer 3, identification information such as the serial number of the digital camera 1, the printing times information, the copying times information, and the number of the times to shift from thumbnail to main image are simultaneously stored. In a case where the image data copied from the digital camera 1 into the personal computer 3 and recorded in the personal computer 3 is used and printed by a printer device 2, when the number of printed sheets is one, one is added to the number of the printing times of the corresponding image data in the image importance degree management file stored in the hard disk 41 of the personal computer 3. Thereafter, the number is overwritten and recorded again. Here, the number of the printed sheets is added as the number of the printing times. Therefore, when the number of the printed sheets is, for example, three, three is added. It is to be noted that only one may be added per printing start instruction regardless of the number of the printed sheets.

In a case where the image data copied from the digital camera 1 into the personal computer 3 is further copied into another recording medium, after one is added to the number of the copying times of the image importance degree management file stored in the hard disk 41 of the personal computer 3, the number is overwritten and recorded again. In a case where the image data copied from the digital camera 1 into the personal computer 3 is shifted from reproduction of thumbnail images to reproduction of a main image in the personal computer 3, after one is added to the number of the times to shift from thumbnail to main image in the image importance degree management file stored in the hard disk 41 of the personal computer 3, the number is overwritten and recorded again.

Moreover, in Example 3, when the digital camera 1 is disconnected from the personal computer 3, the copying times information of the image importance degree management file stored in the hard disk 41 of the personal computer 3 is reset to zero. Moreover, in a case where the digital camera 1 is connected to the personal computer 3 again, the digital camera 1 is notified of the updated number of the copying times of the image importance degree management file stored in the hard disk 41 of the personal computer 3 while the digital camera 1 is disconnected from the personal computer 3. The notified number of the times is added to the number of the copying times in a management data region such as a header or a footer of each image data recorded in a recording medium 17 of the digital camera 1 to update the number.

On the other hand, in Example 9, date information of copying, printing and shift from thumbnail reproduction to main image reproduction are stored in a management data region such as the header or the footer of the image data recorded in the recording medium 17 of the digital camera 1 and the image importance degree management file stored in the hard disk 41 of the personal computer 3. When the date information is recorded in the recording medium 17, the information may be stored in a management file for exclusive use described in Example 8 instead of a management region such as the header or the footer of the image data.

When the digital camera 1 is connected to the personal computer 3 by a USB cable or the like, the digital camera 1 notifies the personal computer 3 of identification information such as the serial number of the digital camera 1 and ID information such as a file number of the image data recorded in the recording medium 17 of the digital camera 1 in response to the connecting operation. When the personal computer 3 detects this notification, the notified serial number of the digital camera 1 is searched from the image importance degree management file stored in the hard disk 41 of the personal computer 3. Next, the notified file number is searched.

When the serial number of the corresponding digital camera is present, substantially the corresponding file number is searched. In a case where in the searched file number, the image data is present which indicates that the printing, the copying and the shift from thumbnail to main image are performed on and after the previous connecting date of the digital camera 1 to the personal computer 3, the personal computer 3 notifies the digital camera 1 of printing date information, copying date information and information of date to shift from thumbnail to main image. The printing date information, the copying date information and the information of the date to shift from thumbnail to main image notified from the personal computer 3 are stored in a management data region such as the header or the footer of the data in the recording medium 17 of the digital camera 1. Moreover, when these pieces of history information on the side of the personal computer are stored on the side of the digital camera, and the history information on the digital camera side is updated, the information on the personal computer side is reset. Thus, once the history information on the personal computer side is reset, the history information on the personal computer side at a time when the digital camera 1 is connected to the personal computer 3 next is the only history information at and after the next connection time. Redundant information may be added to the history information on the digital camera side without being checked to update the information. That is, the redundant information does not have to be checked.

Moreover, when the history information updated on the digital camera side is similarly transmitted from the digital camera 1 to the personal computer 3, and the updated history information is stored in the image importance degree management file of the personal computer 3, both of the digital camera 1 and the personal computer 3 can grasp and manage the history information, and can cope with an accident such as unexpected information erasing (unexpected losing of the image data, history data or the like).

There will be described hereinafter in detail a case where the above history information is stored in the management file for exclusive use. FIG. 29 shows print history information recorded in the image importance degree management file disposed as a file separate from an image file.

FIG. 29A shows data stored in the image importance degree management file of the digital camera 1. The print history information as of May 31, 2003 is stored. According to this print history information, images 101, 103, 105, 106 and 107 are printed once, respectively, an image 102 is printed three times, an image 104 is not printed even once. It is supposed that the image data of the digital camera 1 was digitally copied into the personal computer 3 on Jun. 1, 2003. FIGS. 29B, 29C show print history information including history of the printing thereafter performed independently in the digital camera 1 and the personal computer 3, respectively, by Dec. 30, 2003.

FIG. 29B shows data as of Dec. 30, 2003 in the image importance degree management file of the digital camera 1. It is seen that when and after the image data was copied into the personal computer 3, the digital camera 1 was directly connected to the printer device 2, the image 101 was further printed once, the image 102 was further printed twice, and the image 105 was further printed twice. As a result, the total number of the printing times stored in the image importance degree management file of the digital camera 1 as of Dec. 30, 2003 is two for the image 101, five for the image 102, and three for the image 105. The images 103, 104, 106 and 107 are unchanged as compared with the data as of May 31, 2003.

FIG. 29C shows data as of Dec. 30, 2003 in the image importance degree management file of the hard disk of the personal computer 3. It is seen that when and after the image data was copied from the digital camera 1 into the personal computer 3 on Jun. 1, 2003, the personal computer 3 was directly connected to the printer device 2, the image 102 was further printed once, and the image 107 was further printed once. As a result, the total number of the printing times stored in the image importance degree management file of the personal computer 3 as of Dec. 30, 2003 is four for the image 102, and two for the image 107. The images 101, 103, 104, 105 and 106 are unchanged as compared with the data as of May 31, 2003.

When the digital camera 1 was connected to the personal computer 3 on Dec. 30, 2003, the history data of the image importance degree management file of the personal computer 3 was transmitted from the personal computer 3 to the digital camera 1. In the digital camera 1, the print history data of FIGS. 29B, 29C were synthesized, respectively, to produce new print history data. Here, the print history data produced on the same date is recognized as one data, and is not redundantly counted. For example, as to the image 102, among four print histories of March 11, April 14, May 22 and November 10 transmitted from the personal computer 3 and five print histories of March 11, April 14, May 22, September 16 and December 29 held in the digital camera 1, the print histories of the same print dates of March 11, April 14 and May 22 are recognized to be the same. Moreover, as to the print history of the image 102, in addition to the histories of March 11, April 14 and May 22 before the image data was copied from the digital camera 1 into the personal computer 3, the histories of September 16 and December 29 when the image data on the digital camera side was printed after the data was copied into the personal computer 3 and the history of November 10 when the image data on the personal computer side was printed were newly added as the print histories. Finally, there is obtained the print history synthesized and updated as shown in FIG. 29D. It is seen from FIG. 29D that, for example, the image 102 was printed six times in total. A system controller 26 of the digital camera 1 counts each times information based on these date histories, and converts the information into the times information. This times information can be stored in the management region of each image file together with the date information as the history information. Alternatively, the times information can be stored in the management file for exclusive use independently of the image file together with the history information. Furthermore, the information may be held in both of them, that is, both of the image file and the management file for exclusive use.

According to Example 9, since the personal computer 3 is notified of identification information such as the serial number of the digital camera 1, the digital camera 1 as a transmitter device is confirmed and distinguished by this identification information, and information from a plurality of transmitters can securely be identified and distinguished.

Moreover, the date information independently held in the digital camera and the personal computer and indicating the dates when the printing, the copying and the shift from thumbnail to main image were performed are added up in the digital camera. Thereafter, the information is stored in the management data region of the recording medium 17, and the information on the printing, the copying or the shift from thumbnail to main image performed on the same date is judged to be the same during the addition processing. Redundant addition is prevented with respect to the number of the printing times, the number of the copying times and the number of the times to shift from thumbnail to main image. The total number of the printing times by use of the image data of the digital camera 1 and the image data copied into the personal computer side can correctly be grasped, and the degree of importance of the image can securely be grasped.

There are considered various methods of utilizing the number of the printing times, the number of the copying times and the number of the times to shift from thumbnail to main image. For example, as described in Example 3, when the number of the times is applied to a case where the image data to be erased is automatically selected in order to secure the necessary recording region, the image data as the erasing object is selected regardless of whether or not the image data is new, it is possible to secure the necessary recording region without requiring operator's trouble, and the image data can smoothly be continued. Here, the processing for securing the necessary recording region is not limited to the erasing, and needless to say, the necessary recording region may be secured by the resizing or the compressing.

In Example 9, the number of the printing times has been described, but the example is not limited to the number of the printing times, and may be applied to the number of the copying times and the number of the times to shift from thumbnail to main image. When the total number of the copying times and the total number of the times to shift from thumbnail to main image are grasped, the degree of importance of the image can securely be grasped. Moreover, the weighting described in Example 5 may be performed.

Moreover, in Example 9, regarding the printing on the personal computer side utilizing the image data copied into the personal computer side, the date information history is added to the print history to hold the history on the personal computer side. When the personal computer 3 is connected to the digital camera 1, the only information is transmitted to the digital camera side, and synthesized with the print history information held on the digital camera side to update the information. Therefore, it becomes unnecessary to transmit the print history information from the digital camera side to the personal computer side. Moreover, to synthesize and update the print history data, redundant check for ignoring redundant data is not required. However, when the image data is copied from the digital camera side into the personal computer side, in addition to copy history information, the print history information may be transmitted to the personal computer side and recorded.

Since the image data as the erase, resize or compress processing object is automatically selected based on the number of the printing times, the number of the copying times and the number of the times to shift from thumbnail to main image obtained in accordance with the date history information regardless of whether or not the image data is new, the necessary recording region can be secured without requiring any operator's trouble.

(Other Examples and Modifications)

In Examples 1 to 9, as an image data processing device, a digital camera is used. However, the image data processing device is not limited to the digital camera, and may be replaced with a device having a function equivalent to that of the digital camera.

For example, instead of the digital camera, as the image data processing device, there can be utilized a cellular phone which records data photographed by a camera function in a recording medium and which transmits data to a printer device or a personal computer by a mail function and in which printing and copying are possible.

Moreover, a card reader capable of copying or printing data recorded in a recording medium when connected to the personal computer or the printer device is usable as the image data processing device instead of the digital camera.

Furthermore, a combination of a DVD recorder and a player capable of copying or printing data recorded in a DVD disk when connected to the personal computer or the printer device is usable as the image data processing device instead of the digital camera.

In addition, a personal computer or a television set having a hard disk incorporated therein capable of copying or printing data recorded in the hard disk when connected to the personal computer or the printer device is usable as the image data processing device instead of the digital camera.

Moreover, as systems of Examples 1 to 9, the personal computer is utilized. However, the system is not limited to the personal computer, and may be replaced with a system having a function equivalent to that of the personal computer. As the system, there is considered, for example, a recording medium such as the hard disk or the card reader having a memory function of the recording medium or the like, a digital video camera, a DVD recorder player, a television set having the hard disk incorporate therein or the like.

It is to be noted that in any example, to determine the erasing, resizing or compressing to be performed is an arbitrarily selectable matter. For example, the only erasing has been mentioned as the example, but in addition to the erasing, the resizing or the compressing can needless to say be selected arbitrarily.

Furthermore, needless to say, the present invention include systems and devices obtained by appropriately and arbitrarily selecting and combining the examples.

As described above, according to the present invention, when the recording capacity is running short, the image data as the erasing object or another processing object is automatically selected in accordance with the degree of importance of the image data without forcing the operator to perform a laborious operation such as protection or regardless of whether or not the data is new. Therefore, the storage region required for the photographing is secured, and the image data can smoothly be continued to be recorded.

The present invention is broadly applicable to an image data processing device which records photographed data in a recording medium and which prints or copies the data when electrically connected to a printer device or a personal computer by a cable or radio.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but constructed to cover all modifications that may fall within the scope of the appended claims.

What is claimed is:

1. An image data selecting method comprising:
recording captured image data and image data information on the image data;
including, as the image data information, times information on at least one of:
the number of printing times based on the image data,
the number of copying times of the image data, and
the number of times when display of a plurality of reduced images produced based on the image data shifts to display of the image data before the production of the selected reduced image;
in a case where the image data is selected from a plurality of image data to perform at least one of erase processing, resize processing and compress processing of the image data,
automatically selecting image data as an object of the processing based on the times information;
displaying images based on the selected image data or the reduced images produced based on the selected image data;
executing the processing in response to the subsequent processing start instruction, in a case where any image is not further selected from the displayed images or reduced images; and
subjecting, to the processing, an object which is the image data excluding the image data corresponding to the selected image in response to the subsequent processing start instruction, in a case where the image is further selected from the displayed images or reduced images.

2. An image data selecting method comprising:
recording captured image data and image data information on the image data;
including, as the image data information, times information on at least one of:
the number of printing times based on the image data,
the number of copying times of the image data, and
the number of times when display of a plurality of reduced images produced based on the image data shifts to display of the image data before the production of the selected reduced image;
in a case where the image data is selected from a plurality of image data to perform at least one of erase processing, resize processing and compress processing of the image data,
automatically selecting image data as an object of the processing based on the times information;
displaying the reduced images based on the plurality of image data in a state in which the reduced image produced based on the selected image data is identified after end of the selection;
executing the processing in response to the subsequent processing start instruction, in a case where any image is not further selected from the displayed reduced images; and
subjecting, to the processing, an object which is the image data excluding the image data corresponding to the selected image in response to the subsequent processing start instruction, in a case where the image is further selected from the displayed reduced images.

3. The image data selecting method according to claim 1, further comprising:
subjecting the image which has not further been selected to the at least one processing, in a case where the image is further selected from the displayed images or reduced images; and
subjecting a specific image further selected to processing other than the performed processing.

4. The image data selecting method according to claim 1, further comprising:
including, as the image data information, at least two types of times information on:
the number of the printing times based on the image data,
the number of the copying times of the image data, and
the number of the times when the display of the plurality of reduced images produced based on the image data shifts to the display of the image data before the production of the selected reduced image;
in a case where the image data is selected from the plurality of image data to perform at least one of the erase processing, the resize processing and the compress processing of the image data,
weighting the at least two types of times information, respectively, to add up the information; and
automatically selecting the image data as the processing object based on the addition result.

5. The image data selecting method according to claim 4, further comprising:
defining beforehand a first weighting combination and a second weighting combination different from the first weighting combination with respect to the at least two types of times information; and
switching the first and second weighting combinations in response to switching of weighting.

6. An image data selecting method comprising:
recording captured image data and image data information on the image data;
including, as the image data information, times information on at least one of:
the number of printing times based on the image data,
the number of copying times of the image data, and
the number of times when display of a plurality of reduced images produced based on the image data shifts to display of the image data before the production of the selected reduced image; and
in a case where the image data is selected from a plurality of image data to perform at least one of erase processing, resize processing and compress processing of the image data,
automatically selecting image data as an object of the processing based on the times information.

7. The image data selecting method according to claim 6, wherein the image data is combined with the image data information to form one piece of image information.

8. The image data selecting method according to claim 6, wherein the image data and the image data information are recorded in parallel with each other as independent pieces of information.

9. The image data selecting method according to claim 6, wherein the plurality of image data information concerned with the image data is recorded as one piece of image information.

10. An image data selecting method comprising:
recording captured image data and image data information on the image data;
including, as the image data information, at least two types of times information of:
the number of printing times based on the image data,
the number of copying times of the image data, and
the number of times when display of a plurality of reduced images produced based on the image data shifts to display of the image data before the production of the selected reduced image;
in a case where the image data is selected from a plurality of image data to perform at least one of erase processing, resize processing and compress processing of the image data,
weighting the at least two types of times information, respectively, to add up the information; and
automatically selecting the image data as the processing object based on the addition result.

11. The image data selecting method according to claim 10, further comprising:
defining beforehand a first weighting combination and a second weighting combination different from the first weighting combination with respect to the at least two types of times information; and
switching the first and second weighting combinations in response to switching of weighting.

12. The image data selecting method according to claim 10, wherein in the weighting combinations,
a weighting level of at least one of:
the number of the printing times based on the image data,
the number of the copying times of the image data, and
the number of the times when the display of the plurality of reduced images produced based on the image data shifts to the display of the image data before the production of the selected reduced image is set to zero.

13. The image data selecting method according to claim 6, wherein in a case where after the image data is selected, a recording region of the plurality of image data recorded by subjecting the selected image data to the processing is reduced,
the processing to be performed is set beforehand; and
the set processing is performed in response to a processing start instruction input.

14. The image data selecting method according to claim 13, wherein the number of the image data as objects of the processing is set beforehand.

15. The image data selecting method according to claim 13, wherein the number of the image data as objects of the processing is determined by calculation.

16. The image data selecting method according to claim 15, further comprising:
determining the number of the image data as objects of the processing by calculation, after setting the number of the image data photographable after subjected to the processing.

17. The image data selecting method according to claim 6, wherein the image data having the smallest number of times information is selected in response to an operation to instruct selection start of the image data.

18. The image data selecting method according to claim 6, wherein the image data having the largest number of times information is selected in response to an operation to instruct selection start of the image data.

19. The image data selecting method according to claim 18, further comprising:
in a case where there exist a plurality of image data having the smallest number of the times in the selected times information,
selecting all of the image data.

20. The image data selecting method according to claim 19, further comprising:
in a case where there exist a plurality of image data having the largest number of the times in the selected times information,
selecting all of the image data.

21. The image data selecting method according to claim 18, further comprising:
in a case where there exist a plurality of image data having the smallest number of the times in the selected times information,
preferentially selecting image data having old date information from the plurality of image data.

22. The image data selecting method according to claim 19, further comprising:
in a case where there exist a plurality of image data having the largest number of the times in the selected times information,
preferentially selecting image data having old date information from the plurality of image data.

23. An image data processing device comprising:
a recording section which records captured and image-processed image data and image data information including times information on at least one of the number of printing times based on the image data, the number of copying times of the image data, and the number of times when display of a plurality of reduced images produced based on the image data shifts to display of the image data before the production of the selected reduced image;
an image data selecting section which automatically selects image data as an object of at least one of erase processing, resize processing and compress processing of the image data based on the times information;
a display section which displays images based on the image data selected by the image data selecting section or the reduced images produced based on the selected image data;
a displayed image data selecting section which further selects an image from the images or the reduced images displayed in the display section;
a processing start instructing section which instructs execution of the at least one processing, in a case where the displayed image data selecting section does not further select the image from the images or the reduced images displayed in the display section, the processing start instructing section being configured to instruct execution of the at least one processing with respect to an object which is the image data excluding the image data corresponding to the selected image, in a case where the displayed image data selecting section further selects the image from the images or the reduced images displayed in the display section; and
an image data processing section which executes the at least one processing in response to the processing start instruction from the processing start instructing section.

24. An image data processing device comprising:
a recording section which records captured and image-processed image data and image data information including times information on at least one of the number of printing times based on the image data, the number of copying times of the image data, and the number of times when display of a plurality of reduced images produced based on the image data shifts to display of the image data before the production of the selected reduced image;
an image data selecting section which automatically selects image data as an object of at least one of erase processing, resize processing and compress processing of the image data based on the times information;
a display section which displays images based on the image data selected by the image data selecting section or the reduced images produced based on the image data selected by the image data selecting section in an identifiable state;
a displayed image data selecting section which further selects an image from the images or the reduced images displayed in the display section;
a processing start instructing section which instructs execution of the at least one processing, in a case where the displayed image data selecting section does not further select the image from the images or the reduced images displayed in the display section, the processing start instructing section being configured to instruct execution of the at least one processing with respect to an object which is the image data excluding the image data corresponding to the selected image, in a case where the displayed image data selecting section further selects the image from the images or the reduced images displayed in the display section; and
an image data processing section which executes the at least one processing in response to the processing start instruction from the processing start instructing section.

25. The image data processing device according to claim 23, wherein in a case where the displayed image data selecting section further selects a specific image from the images or the reduced images displayed in the display section,
the image which has not further been selected is subjected to the at least one processing; and
the further selected image is subjected to processing other than the performed processing.

26. The image data processing device according to claim 23, wherein the recording section records, as the image data information, at least two types of times information on:
the number of the printing times based on the image data,
the number of the copying times of the image data, and
the number of the times when the display of the plurality of reduced images produced based on the image data shifts to the display of the image data before the production of the selected reduced image; and
the image data selecting section weights the plurality of types of times information, respectively,
performs accumulation after the plurality of types of times information corresponding to the respective image data are weighted, respectively, and
automatically selects the image data as the object of at least one of the erase processing, the resize processing and the compression processing of the image data from a plurality of image data based on the accumulation result.

27. The image data processing device according to claim 26, wherein:
a first weighting combination and a second weighting combination different from the first weighting combination are defined beforehand with respect to the at least two types of times information;
the device further comprising:
switching means for switching the first and second weighting combinations.

28. An image data processing device comprising:
a recording section which records captured and image-processed image data and image data information including times information on at least one of the number of printing times based on the image data, the number of copying times of the image data, and the number of times when display of a plurality of reduced images produced based on the image data shifts to display of the image data before the production of the selected reduced image;
an image data selecting section which automatically selects image data as an object of at least one of erase processing, resize processing and compress processing of the image data based on the times information; and
an image data processing section which performs at least one of the erase processing, the resize processing and the compress processing of the image data with respect to the image data as the processing object selected by the image data selecting section.

29. The image data processing device according to claim 28, wherein the image data is combined with the image data information to form one piece of image information and recorded in the recording section.

30. The image data processing device according to claim 28, wherein the image data and the image data information are recorded in the recording section in parallel with each other as independent pieces of information.

31. The image data processing device according to claim 28, wherein the plurality of image data information concerned with the image data is recorded as one piece of image information in the recording section.

32. An image data processing device comprising:
a recording section which records captured and image-processed image data and image data information including at least two types of times information of the number of printing times based on the image data, the number of copying times of the image data, and the number of times when display of a plurality of reduced images produced based on the image data shifts to display of the image data before the production of the selected reduced image;
an image data selecting section which weights the at least two types of times information, respectively, to add up the information and which automatically selects the image data as an object of at least one of erase processing, resize processing and compress processing of the image data from a plurality of image data based on the addition result; and
an image data processing section which subjects the selected image data to at least one of the erase processing, the resize processing and the compress processing of the image data.

33. The image data processing device according to claim 32, wherein a first weighting combination and a second weighting combination different from the first weighting combination are defined beforehand with respect to the at least two types of times information,
the device further comprising:
a switching section which switches the first and second weighting combinations.

34. The image data processing device according to claim 32, wherein in the weighting combinations,
a weighting level of at least one of:
the number of the printing times based on the image data,
the number of the copying times of the image data, and
the number of the times when the display of the plurality of reduced images produced based on the image data shifts to the display of the image data before the production of the selected reduced image is set to zero.

35. The image data processing device according to claim 28, further comprising:
a setting section which sets beforehand the processing to be performed; and
a processing start instructing section which instructs selection start of the image data,
wherein in a case where after the image data selected by the image data selecting section is subjected to the processing to reduce a recording region of the plurality of image data recorded in the recording section,
the processing set by the setting section is performed in response to the start instruction from the processing start instructing section.

36. The image data processing device according to claim 35, wherein the number of the image data as objects of the processing is set beforehand.

37. The image data processing device according to claim 35, wherein the number of the image data as objects of the processing is determined by calculation.

38. The image data processing device according to claim 37, wherein the number of the image data as objects of the processing is determined by calculation, after setting the number of the image data photographable after subjected to the processing.

39. The image data processing device according to claim 28, further comprising:
a selection start instructing section which instructs selection start of the image data,
wherein the image data having the smallest number of the times of the times information is selected in response to an operation to the selection start of the selection start instructing section.

40. The image data processing device according to claim 28, further comprising:
a selection start instructing section which instructs selection start of the image data,
wherein the image data having the largest number of the times of the times information is selected in response to an operation of the selection start of the selection start instructing section.

41. The image data processing device according to claim 39, wherein in a case where there exist a plurality of image data having the smallest number of the times in the selected times information,
all of the image data are selected.

42. The image data processing device according to claim 40, wherein in a case where there exist a plurality of image data having the largest number of the times in the selected times information, all of the image data are selected.

43. The image data processing device according to claim 39, wherein in a case where there exist a plurality of image data having the smallest number of the times in the selected times information, image data having old date information is preferentially selected from the plurality of image data.

44. The image data processing device according to claim 40, wherein in a case where there exist a plurality of image data having the largest number of the times in the selected times information, image data having old date information is preferentially selected from the plurality of image data.
